(19) United States
(12) Patent Application Publication
(10) Pub. No.: US 2025/0234297 A1
(43) Pub. Date: Jul. 17, 2025

(54) RADIO FREQUENCY EXPOSURE COMPLIANCE AMONG RADIOS

(71) Applicant: QUALCOMM Incorporated, San Diego, CA (US)

(72) Inventors: Jagadish NADAKUDUTI, Bermuda Dunes, CA (US); Akhil DEODHAR, Louisville, CO (US); Nandhini SRINIVASAN, San Diego, CA (US); Scott HOOVER, Del Mar, CA (US); Huang LOU, Santee, CA (US); Lin LU, San Diego, CA (US); Troy CURTISS, Boulder, CO (US)

(21) Appl. No.: 19/026,009

(22) Filed: Jan. 16, 2025

Related U.S. Application Data
(60) Provisional application No. 63/622,014, filed on Jan. 17, 2024.

(51) Int. Cl. H04W 52/02

(52) U.S. Cl. CPC H04W 52/0261

(57) ABSTRACT

Techniques and apparatus for operating a wireless communication device pursuant to RF exposure compliance are provided. An example method generally includes: when an RFECS1 of the wireless device is in an online state, controlling, via the RFECS1, at least one of first radio(s) associated with a first RAT or second radio(s) associated with a second RAT, in compliance with an RF exposure limit and based on at least one of first RF exposure information associated with the first radio(s) or second RF exposure information associated with the second radio(s); when the RFECS1 transitions from the online state to being unavailable, obtaining, by an RFECS2 of the wireless device, third RF exposure information associated with the second radio(s); and when the RFECS1 is unavailable, controlling, via the RFECS2, the second radio(s) in compliance with the RF exposure limit and based at least in part on the third RF exposure information.

### CROSS-REFERENCE TO RELATED APPLICATION

This application claims the benefit of U.S. Provisional Patent Application Ser. No. 63/622,014, filed Jan. 17, 2024, which is hereby incorporated by reference herein in its entirety for all applicable purposes.

### INTRODUCTION

### Field of the Disclosure

Aspects of the present disclosure relate to wireless communications, and more particularly, to optimizing (or at least improving) communication performance while ensuring radio frequency (RF) exposure compliance among radios operating in a wireless communication device.

### DESCRIPTION OF RELATED ART

Wireless communication systems are widely deployed to provide various telecommunication services such as telephony, video, data, messaging, broadcasts, etc. Modern wireless communication devices (such as cellular telephones) are generally mandated to meet radio frequency (RF) exposure limits set by certain governments and international standards and regulations. To ensure compliance with the standards, such devices currently undergo an extensive certification process prior to being shipped to market. To ensure that a wireless communication device complies with an RF exposure limit, techniques have been developed to enable the wireless communication device to assess RF exposure from the wireless communication device and adjust the transmission power of the wireless communication device accordingly to comply with the RF exposure limit.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description,” one will understand how the features of this disclosure provide advantages that include maintaining radio frequency (RF) exposure compliance during and following transitions among RF exposure control schemes.

Certain aspects of the subject matter described in this disclosure can be implemented in a method for wireless communication by a wireless device. The method generally includes: when a first radio frequency (RF) exposure control scheme of the wireless device is in an online state, controlling, via the first RF exposure control scheme, at least one of (i) one or more first radios associated with a first radio access technology (RAT) or (ii) one or more second radios associated with a second RAT, in compliance with an RF exposure limit and based on at least one of first RF exposure information associated with the one or more first radios or second RF exposure information associated with the one or more second radios; when the first RF exposure control scheme transitions from the online state to being unavailable, obtaining, by a second RF exposure control scheme of the wireless device, configuration information associated with the first RF exposure control scheme from at least one storage location associated with the first RF exposure control scheme; and when the first RF exposure control scheme is unavailable, controlling, via the second RF exposure control scheme, the at least one of (i) the one or more first radios or (ii) the one or more second radios, in compliance with the RF exposure limit and based on the configuration information and at least one of the first RF exposure information or the second RF exposure information.

Certain aspects of the subject matter described in this disclosure can be implemented in an apparatus for wireless communication. The apparatus includes one or more memories collectively storing computer-executable instructions, and one or more processors coupled to the one or more memories. The one or more processors are collectively configured to execute the computer-executable instructions to cause the apparatus to perform an operation. The operation includes: when a first radio frequency (RF) exposure control scheme of the apparatus is in an online state, controlling, via the first RF exposure control scheme, at least one of (i) one or more first radios associated with a first radio access technology (RAT) or (ii) one or more second radios associated with a second RAT, in compliance with an RF exposure limit and based on at least one of first RF exposure information associated with the one or more first radios or second RF exposure information associated with the one or more second radios; when the first RF exposure control scheme transitions from the online state to being unavailable, obtaining, by a second RF exposure control scheme of the apparatus, configuration information associated with the first RF exposure control scheme from at least one storage location associated with the first RF exposure control scheme; and when the first RF exposure control scheme is unavailable, controlling, via the second RF exposure control scheme, the at least one of (i) the one or more first radios or (ii) the one or more second radios, in compliance with the RF exposure limit and based on the configuration information and at least one of the first RF exposure information or the second RF exposure information.

Certain aspects of the subject matter described in this disclosure can be implemented in an apparatus for wireless communication. The apparatus generally includes: when a first radio frequency (RF) exposure control scheme of the apparatus is in an online state, means for controlling, via the first RF exposure control scheme, at least one of (i) one or more first radios associated with a first radio access technology (RAT) or (ii) one or more second radios associated with a second RAT, in compliance with an RF exposure limit and based on at least one of first RF exposure information associated with the one or more first radios or second RF exposure information associated with the one or more second radios; when the first RF exposure control scheme transitions from the online state to being unavailable, means for obtaining, by a second RF exposure control scheme of the apparatus, configuration information associated with the first RF exposure control scheme from at least one storage location associated with the first RF exposure control scheme; and when the first RF exposure control scheme is unavailable, means for controlling, via the second RF exposure control scheme, the at least one of (i) the one or more first radios or (ii) the one or more second radios, in compliance with the RF exposure limit and based on the configuration information and at least one of the first RF exposure information or the second RF exposure information.

Certain aspects of the subject matter described in this disclosure can be implemented in a computer-readable medium. The computer-readable medium has instructions stored thereon for performing an operation. The operation includes: when a first radio frequency (RF) exposure control scheme of a wireless device is in an online state, controlling, via the first RF exposure control scheme, at least one of (i) one or more first radios associated with a first radio access technology (RAT) or (ii) one or more second radios associated with a second RAT, in compliance with an RF exposure limit and based on at least one of first RF exposure information associated with the one or more first radios or second RF exposure information associated with the one or more second radios; when the first RF exposure control scheme transitions from the online state to being unavailable, obtaining, by a second RF exposure control scheme of the wireless device, configuration information associated with the first RF exposure control scheme from at least one storage location associated with the first RF exposure control scheme; and when the first RF exposure control scheme is unavailable, controlling, via the second RF exposure control scheme, the at least one of (i) the one or more first radios or (ii) the one or more second radios, in compliance with the RF exposure limit and based on the configuration information and at least one of the first RF exposure information or the second RF exposure information.

Certain aspects of the subject matter described in this disclosure can be implemented in a method for wireless communication by a wireless device. The method generally includes: when a first radio frequency (RF) exposure control scheme of the wireless device is in an online state, controlling, via the first RF exposure control scheme, at least one of (i) one or more first radios associated with a first radio access technology (RAT) or (ii) one or more second radios associated with a second RAT, in compliance with an RF exposure limit and based on at least one of first RF exposure information associated with the one or more first radios or second RF exposure information associated with the one or more second radios; when the first RF exposure control scheme transitions from the online state to being unavailable, obtaining, by a second RF exposure control scheme of the wireless device, third RF exposure information associated with the one or more second radios; and when the first RF exposure control scheme is unavailable, controlling, via the second RF exposure control scheme, the one or more second radios in compliance with the RF exposure limit and based at least in part on the third RF exposure information.

Certain aspects of the subject matter described in this disclosure can be implemented in an apparatus for wireless communication. The apparatus includes one or more memories collectively storing computer-executable instructions, and one or more processors coupled to the one or more memories. The one or more processors are collectively configured to execute the computer-executable instructions to cause the apparatus to perform an operation. The operation includes: when a first radio frequency (RF) exposure control scheme of the apparatus is in an online state, controlling, via the first RF exposure control scheme, at least one of (i) one or more first radios associated with a first radio access technology (RAT) or (ii) one or more second radios associated with a second RAT, in compliance with an RF exposure limit and based on at least one of first RF exposure information associated with the one or more first radios or second RF exposure information associated with the one or more second radios; when the first RF exposure control scheme transitions from the online state to being unavailable, obtaining, by a second RF exposure control scheme of the apparatus, third RF exposure information associated with the one or more second radios; and when the first RF exposure control scheme is unavailable, controlling, via the second RF exposure control scheme, the one or more second radios in compliance with the RF exposure limit and based at least in part on the third RF exposure information.

Certain aspects of the subject matter described in this disclosure can be implemented in an apparatus for wireless communication. The apparatus generally includes: when a first radio frequency (RF) exposure control scheme of the apparatus is in an online state, means for controlling, via the first RF exposure control scheme, at least one of (i) one or more first radios associated with a first radio access technology (RAT) or (ii) one or more second radios associated with a second RAT, in compliance with an RF exposure limit and based on at least one of first RF exposure information associated with the one or more first radios or second RF exposure information associated with the one or more second radios; when the first RF exposure control scheme transitions from the online state to being unavailable, means for obtaining, by a second RF exposure control scheme of the apparatus, third RF exposure information associated with the one or more second radios; and when the first RF exposure control scheme is unavailable, means for controlling, via the second RF exposure control scheme, the one or more second radios in compliance with the RF exposure limit and based at least in part on the third RF exposure information.

Certain aspects of the subject matter described in this disclosure can be implemented in a computer-readable medium. The computer-readable medium has instructions stored thereon for performing an operation. The operation includes: when a first radio frequency (RF) exposure control scheme of a wireless device is in an online state, controlling, via the first RF exposure control scheme, at least one of (i) one or more first radios associated with a first radio access technology (RAT) or (ii) one or more second radios associated with a second RAT, in compliance with an RF exposure limit and based on at least one of first RF exposure information associated with the one or more first radios or second RF exposure information associated with the one or more second radios; when the first RF exposure control scheme transitions from the online state to being unavailable, obtaining, by a second RF exposure control scheme of the wireless device, third RF exposure information associated with the one or more second radios; and when the first RF exposure control scheme is unavailable, controlling, via the second RF exposure control scheme, the one or more second radios in compliance with the RF exposure limit and based at least in part on the third RF exposure information.

Other aspects provide: an apparatus operable, configured, or otherwise adapted to perform any one or more of the aforementioned methods and/or those described elsewhere herein; a non-transitory, computer-readable medium comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example wireless communication network, in accordance with certain aspects of the present disclosure.

FIG. 2 is a block diagram conceptually illustrating a design of an example a base station (BS) and user equipment (UE), in accordance with certain aspects of the present disclosure.

FIG. 3 is a block diagram of an example radio frequency (RF) transceiver, in accordance with certain aspects of the present disclosure.

FIGS. 4A, 4B, and 4C are graphs illustrating examples of transmit powers over time in compliance with a time-averaged RF exposure limit, in accordance with certain aspects of the present disclosure.

FIGS. 5 and 6 are diagrams illustrating examples of RF exposure control solution transitions over time.

FIG. 7A is a diagram of an example logical architecture for exchanging RF exposure information when a primary RF exposure control scheme is online, in accordance with certain aspects of the present disclosure.

FIG. 7B is a diagram of an example logical architecture for exchanging RF exposure information when a primary RF exposure control scheme is unavailable, in accordance with certain aspects of the present disclosure.

FIG. 8 is a diagram illustrating an example of RF exposure control scheme transitions over time, in accordance with certain aspects of the present disclosure.

FIG. 9 is a flow diagram illustrating example operations for wireless communication by a wireless device, in accordance with certain aspects of the present disclosure.

FIG. 10 is a flow diagram illustrating example operations for wireless communication by a wireless device, in accordance with certain aspects of the present disclosure.

FIG. 11 is a flow diagram illustrating example operations for wireless communication by a wireless device, in accordance with certain aspects of the present disclosure.

FIG. 12 illustrates a communications device (e.g., a UE) that may include various components configured to perform operations for the techniques disclosed herein, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer-readable mediums for optimizing (or at least improving) communication performance of a multi-tech/multi-band wireless communication device while ensuring radio frequency (RF) compliance among radios operating in the multi-tech/multi-band wireless communication device.

For example, a wireless communication device may include one or more radios (implemented on one or more chipsets) that support multiple radio access technologies (RATs), such as Fifth Generation (5G) New Radio (NR), Evolved Universal Terrestrial Radio Access (E-UTRA) (e.g., a Fourth Generation (4G) RAT), Universal Mobile Telecommunications System (UMTS) and/or code division multiple access (CDMA) (e.g., a Second Generation (2G)/Third Generation (3G) RAT), Institute of Electrical and Electronics Engineers (IEEE) 802.11 (e.g., WiFi), Bluetooth access technologies, non-terrestrial (e.g., satellite) communications, peer-to-peer (P2P) or device-to-device (D2D) communications, vehicle-to-everything (V2X) communications, and/or other communications. In an illustrative, non-limiting example, the wireless communication device may include a wireless wide area network (WWAN) radio (or chipset) that supports WWAN RAT(s) (e.g., 5G NR, E-UTRA, UMTS, CDMA, etc.), a wireless local area network (WLAN) radio (or chipset) that supports WLAN RAT(s) (e.g., IEEE 802.11 or WiFi), a Bluetooth radio (or chipset) that supports Bluetooth access technologies, a radio (or chipset) that supports non-terrestrial communications (e.g., satellite communications), or a combination thereof. A chipset may include one or more types of radios.

Additionally, certain wireless communication devices may have multiple RF exposure control schemes, where each RF exposure control scheme may manage the RF exposure for one or more radios. However, one issue with wireless communication devices with multiple radios is that, when a wireless communication device transitions from radios that are controlled by different RF exposure control schemes, the RF exposure may be in non-compliance of an RF exposure limit for a short duration (e.g., less than a time window associated with a time-averaged RF exposure limit).

Aspects of the present disclosure provide apparatus and methods for ensuring RF exposure compliance (e.g., total time-averaged RF exposure compliance) among radios (e.g., WWAN, WLAN, Bluetooth, etc.) in a wireless communication device. In certain aspects described below, a wireless communication device may use a primary RF exposure control scheme to manage RF exposure of a first set of radios (e.g., a WWAN radio and a WLAN and/or Bluetooth radio) in compliance with an RF exposure limit when the primary RF exposure control scheme is active, and may use a secondary RF exposure control scheme to manage RF exposure of (i) the first set of radios (e.g., the WWAN radio and the WLAN/Bluetooth radio) or (ii) a subset of the first set of radios (e.g., the WLAN/Bluetooth radio) when the primary RF exposure control scheme is unavailable (e.g., offline or inactive).

Additionally, in certain aspects, the wireless communication device described herein may use an applications processor (or, in general, any storage or processor separate from the primary RF exposure control scheme) as an intermediate stage (i.e., an intermediary) between different radios, such as a WWAN radio and a WLAN/Bluetooth radio, to store RF exposure information for one or more of the radios. Such RF exposure information may include RF exposure reports/limits, on-off information of radios operating across the chipset(s) (including sleep/wakeup cycles), and other configuration parameters, as illustrative, non-limiting examples.

By using storage or a processor external to the primary RF exposure control scheme (e.g., the applications processor) as an intermediate stage to store RF exposure information for one or more radios (or chipsets), certain aspects of the present disclosure can enable the wireless communication device to maintain RF compliance when transitioning between RF exposure control schemes. For example, the external storage/processor can store the past RF exposure information from radios associated with the secondary RF exposure control scheme for a duration of time that the primary RF exposure control scheme was unavailable (e.g., offline or inactive). When the primary RF exposure control scheme transitions from being unavailable (e.g., from an offline state) to an online state, the primary RF exposure control scheme may obtain the past RF exposure information from the external storage/processor and use the past RF exposure information to maintain RF compliance across the active radios with an RF exposure limit. For example, the primary RF exposure control scheme may provide exposure limits to each of the active radios for a future time interval, such that the RF compliance (e.g., total time-averaged exposure) is maintained across all radios.

Additionally, in certain aspects, the wireless communication device may control the transmission power level(s) of active radio(s) using various techniques described herein in order to maintain RF compliance across the radios.

For example, when the primary RF exposure control scheme is in the online state, the wireless communication device may control the transmission power level(s) of the active radios via the primary RF exposure control scheme. Such active radios can include radios from one or more chipsets, including one or more WWAN radios (or a WWAN chipset), one or more WLAN radios (or a WLAN chipset), and one or more Bluetooth radios (or a Bluetooth chipset), as illustrative, non-limiting examples. If certain active radios (e.g., the WLAN/Bluetooth radio) have not received a transmission power level target from the primary RF exposure control scheme for a predetermined period of time (e.g., 5 seconds or some other amount of time), then the wireless communication device may control the transmission power level(s) of these active radios based on a previously granted reserve level (from the primary RF exposure control scheme) for a predetermined duration and, after the predetermined duration, may control the transmission power level(s) of these active radios based on a preconfigured transition reserve level. The transition reserve level may be lower than the granted reserve level.

In some cases, the primary RF exposure control scheme may not receive RF exposure information from certain radios (e.g., the WLAN/Bluetooth radio), since different radios may go through different sleep cycles. In such cases, the primary RF exposure control scheme may assume that these radios have transmitted at an allocated RF exposure limit (instead of a zero RF exposure limit). That is, the primary RF exposure control scheme may treat missed reports from WLAN and/or Bluetooth radios as transmitted exposure history so that the RF exposure margin is not allocated to other radios (e.g., the WWAN radio). In this manner, the wireless communication device can avoid the same RF exposure margin being used by two different radios which can result in non-compliance with an RF exposure limit and/or radio link failures. In certain aspects, after the primary RF exposure control scheme receives actual RF exposure reports associated with these radios (e.g., from the applications processor), the primary RF exposure control scheme may replace the missed reports in the exposure history with the actual RF exposure reports to avoid operating at a lower performance (e.g., since the missed reports may assume the worst-case scenario of the entire exposure budget being utilized by the WLAN/Bluetooth radios).

When the primary RF exposure control scheme is unavailable (e.g., in the offline state), the wireless communication device may control the transmission power level(s) of the active radios based on the preconfigured transition reserve level for a single time window of the primary RF exposure control scheme, and, after the time window has elapsed, control the transmission power level(s) of the active radios via the secondary RF exposure control scheme. In this manner, aspects described herein may enable the wireless communication device to avoid temporal non-compliance with an RF exposure limit when transitioning between radios that are controlled by different RF exposure control schemes.

Note, in certain aspects described herein, certain types of radios, such as Bluetooth, may be controlled to operate at fixed transmission power levels in order to have consistent performance for applications (e.g., audio), compared to other types of radios, such as WWAN/WLAN radios.

The apparatus and methods for ensuring RF exposure compliance described herein may facilitate improved wireless communication performance, such as reduced latencies, increased data rates, improved signal qualities (e.g., at a cell's edge), and/or increased range of communications, for example, due to the transmit powers allowed for the various radios.

Further, one potential drawback with using an external storage/processor (e.g., the applications processor) as an intermediate stage among one or more modems/radios/chipsets is that waking up the external storage/processor can consume a significant amount of battery power. That is, external storage/processor wakeups may be significant battery consumption events as each wakeup may last for couple hundreds of milliseconds. Accordingly, it may be desirable to provide techniques for optimizing, or at least decreasing, the battery power consumption when using an external storage/processor to ensure RF compliance among radios in a wireless communication device.

As used herein, a radio may refer to a physical or logical transmission path associated with one or more frequency bands (carriers, channels, bandwidths, subdivisions thereof, etc.), transceivers, and/or RATs (e.g., WWAN (such as CDMA, Long Term Evolution (LTE), NR, etc.), WLAN (such as IEEE 802.11), short-range communications (such as Bluetooth), non-terrestrial communications, D2D communications, V2X communications, etc.) used for wireless communications. For example, for uplink carrier aggregation (or multi-connectivity) in WWAN communications, each of the active component carriers used for wireless communications may be treated as a separate radio. Similarly, multi-band transmissions for WLAN communications may be treated as separate radios for each band (e.g., 2.4 gigahertz (GHz), 5 GHZ, or 6 GHz). As used herein, an RF exposure control scheme may refer to an RF exposure manager.

Note while certain aspects described herein may refer radios operating across different chipsets, aspects of the present disclosure may also be applied to other configurations in which two or more radios may be combined on the same chipset (e.g., WWAN/WLAN on the same chip) or various groupings of radios across chips. Similarly, while certain aspects described herein may refer to storage associated with an applications processor being used to store various RF exposure information, in general, any storage or processor that is external to the primary RF exposure control scheme (or more specifically, external to the integrated circuit configured to implement the primary RF exposure control scheme) may be used to store various RF exposure information described herein.

The following description provides examples of RF exposure compliance in communication systems, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

In general, any number of wireless networks may be deployed in a given geographic area. Each wireless network may support a particular RAT and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs, or may support multiple RATs.

The techniques described herein may be used for various wireless networks and radio technologies. While aspects may be described herein using terminology commonly associated with 3G, 4G, and/or new radio (e.g., 5G NR) wireless technologies, aspects of the present disclosure can be applied in other generation-based communication systems and/or to wireless technologies such as 802.11, 802.15, etc.

NR access may support various wireless communication services, such as enhanced mobile broadband (eMBB) targeting wide bandwidth (e.g., 80 megahertz (MHz) or beyond), millimeter wave (mmWave) targeting high carrier frequency (e.g., 24 GHz to 53 GHz or beyond), massive machine type communications (MTC) (mMTC) targeting non-backward compatible MTC techniques, and/or mission critical targeting ultra-reliable low-latency communications (URLLC). These services may include latency and reliability demands. These services may also have different transmission time intervals (TTIs) to meet respective quality of service (QOS) specifications. In addition, these services may co-exist in the same subframe.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). The frequencies between FR1 and FR2 are often referred to as mid-band frequencies. Although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

NR supports beamforming, and beam direction may be dynamically configured. Multiple-input, multiple-output (MIMO) transmissions with precoding may also be supported, as may multi-layer transmissions. Aggregation of multiple cells may be supported.

### Example Wireless Communication Network and Devices

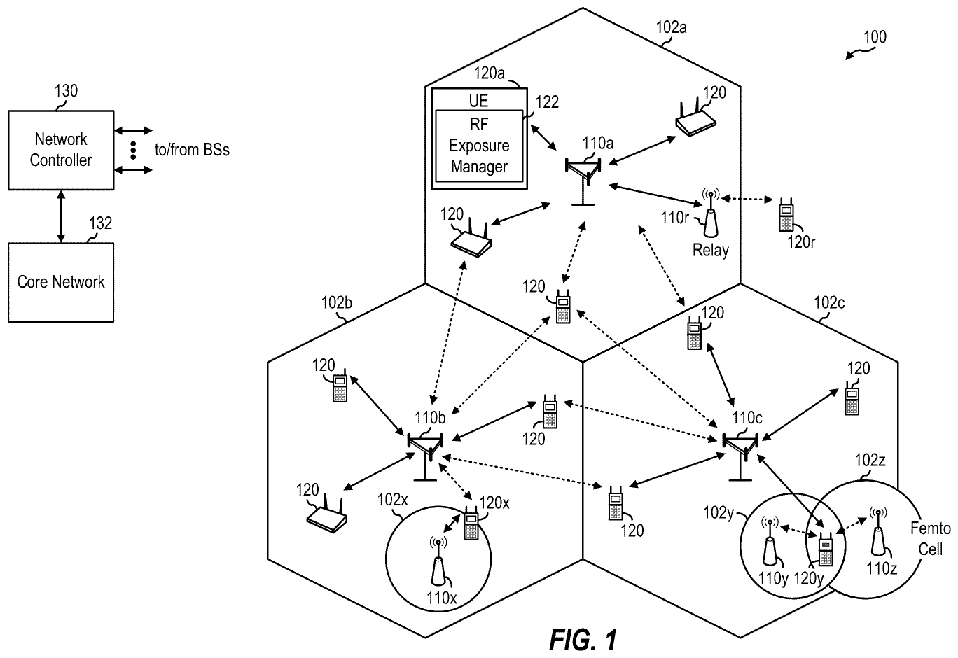

FIG. 1 illustrates an example wireless communication network 100 in which aspects of the present disclosure may be performed. For example, the wireless communication network 100 may include a WWAN and/or a WLAN. A WWAN may include an NR system (e.g., a 5G NR network), an E-UTRA system (e.g., a 4G network), a UMTS (e.g., a 2G/3G network), or a CDMA system (e.g., a 2G/3G network), any future WWAN system, or any combination thereof. A WLAN may include a wireless network configured for communications according to an IEEE standard such as one or more of the 802.11 standards, etc. In some cases, the wireless communication network 100 may include a D2D communications network or a short-range communications system, such as Bluetooth communications or radio frequency identification (RFID) signaling.

As shown in FIG. 1, the UE 120a includes an RF exposure manager 122 that ensures RF exposure compliance among radios in the wireless communication device, for example, in accordance with certain aspects of the present disclosure. Another wireless device in the wireless communication network 100 may alternatively or additionally include an RF exposure manager. For example, one or more of the BSs 110 may be configured as a customer premises equipment (CPE), and an RF exposure manager configured as described herein may be implemented in a BS or CPE.

The wireless communication network 100 may include a number of BSs 110a-z (each also individually referred to herein as BS 110 or collectively as BSs 110) and other network entities. A BS 110 may provide communication coverage for a particular geographic area, sometimes referred to as a “cell,” which may be stationary or may move according to the location of a mobile BS. In some examples, the BSs 110 may be interconnected to one another and/or to one or more other BSs or network nodes (not shown) in wireless communication network 100 through various types of backhaul interfaces (e.g., a direct physical connection, a wireless connection, a virtual network, or the like) using any suitable transport network. In the example shown in FIG. 1, the BSs 110a, 110b, and 110c may be macro BSs for the macro cells 102a, 102b, and 102c, respectively. The BS 110x may be a pico BS for a pico cell 102x. The BSs 110y and 110z may be femto BSs for the femto cells 102y and 102z, respectively. A BS may support one or multiple cells.

The BSs 110 communicate with UEs 120a-y (each also individually referred to herein as UE 120 or collectively as UEs 120) in the wireless communication network 100. The UEs 120 (e.g., 120x, 120y, etc.) may be dispersed throughout the wireless communication network 100, and each UE 120 may be stationary or mobile. Wireless communication network 100 may also include relay stations (e.g., relay station 110r), also referred to as relays or the like, that receive a transmission of data and/or other information from an upstream station (e.g., a BS 110a or a UE 120r) and sends a transmission of the data and/or other information to a downstream station (e.g., a UE 120 or a BS 110), or that relays transmissions between UEs 120, to facilitate communication between devices.

A network controller 130 may be in communication with a set of BSs 110 and provide coordination and control for these BSs 110 (e.g., via a backhaul). In certain cases, the network controller 130 may include a centralized unit (CU) and/or a distributed unit (DU), for example, in a 5G NR system. In some aspects, the network controller 130 may be in communication with a core network 132 (e.g., a 5G Core Network (5GC)), which provides various network functions such as access and mobility management, session management, user plane function, policy control function, authentication server function, unified data management, application function, network exposure function, network repository function, network slice selection function, etc.

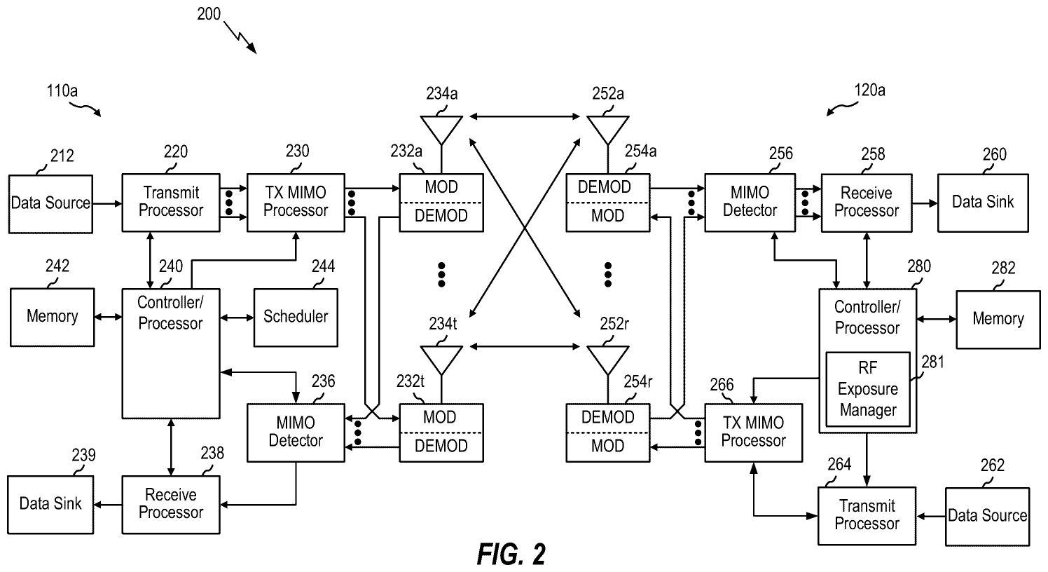

FIG. 2 illustrates example components of BS 110a and UE 120a (e.g., the wireless communication network 100 of FIG. 1), which may be used to implement aspects of the present disclosure.

At the BS 110a, a transmit processor 220 may receive data from a data source 212 and control information from a controller/processor 240. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), etc. The data may be for the physical downlink shared channel (PDSCH), etc. A medium access control (MAC)-control element (MAC-CE) is a MAC layer communication structure that may be used for control command exchange between wireless nodes. The MAC-CE may be carried in a shared channel such as a PDSCH, a physical uplink shared channel (PUSCH), or a physical sidelink shared channel (PSSCH).

The processor 220 may process (e.g., encode and symbol map) the data and control information to obtain data symbols and control symbols, respectively. The transmit processor 220 may also generate reference symbols, such as for the primary synchronization signal (PSS), secondary synchronization signal (SSS), PBCH demodulation reference signal (DMRS), and channel state information reference signal (CSI-RS). A transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream (e.g., for orthogonal frequency division multiplexing (OFDM), etc.) to obtain an output sample stream. Each of the transceivers 232a-232t may further process (e.g., convert to analog, amplify, filter, and upconvert) the output sample stream to obtain a downlink signal. Downlink signals from the transceivers 232a-232t may be transmitted via the antennas 234a-234t, respectively.

At the UE 120a, the antennas 252a-252r may receive the downlink signals from the BS 110a and may provide received signals to the transceivers 254a-254r, respectively. The transceivers 254a-254r may condition (e.g., filter, amplify, downconvert, and digitize) a respective received signal to obtain input samples. Each demodulator (DEMOD) in the transceivers 232a-232t may further process the input samples (e.g., for OFDM, etc.) to obtain received symbols. A MIMO detector 256 may obtain received symbols from all the demodulators in transceivers 254a-254r, perform MIMO detection on the received symbols if applicable, and provide detected symbols. A receive processor 258 may process (e.g., demodulate, deinterleave, and decode) the detected symbols, provide decoded data for the UE 120a to a data sink 260, and provide decoded control information to a controller/processor 280.

On the uplink, at UE 120a, a transmit processor 264 may receive and process data (e.g., for the physical uplink shared channel (PUSCH)) from a data source 262 and control information (e.g., for the physical uplink control channel (PUCCH)) from the controller/processor 280. The transmit processor 264 may also generate reference symbols for a reference signal (e.g., for the sounding reference signal (SRS)). The symbols from the transmit processor 264 may be precoded by a TX MIMO processor 266 if applicable, further processed by the modulators (MODs) in transceivers 254a-254r (e.g., for single-carrier frequency division multiplexing (SC-FDM), etc.), and transmitted to the BS 110a. At the BS 110a, the uplink signals from the UE 120a may be received by the antennas 234, processed by the demodulators in transceivers 232a-232t, detected by a MIMO detector 236 if applicable, and further processed by a receive processor 238 to obtain decoded data and control information sent by the UE 120a. The receive processor 238 may provide the decoded data to a data sink 239 and the decoded control information to the controller/processor 240.

The memories 242 and 282 may store data and program codes for BS 110a and UE 120a, respectively. A scheduler 244 may schedule UEs for data transmission on the downlink and/or uplink.

Antennas 252, processors 266, 258, 264, and/or controller/processor 280 of the UE 120a and/or antennas 234, processors 220, 230, 238, and/or controller/processor 240 of the BS 110a may be used to perform the various techniques and methods described herein. As shown in FIG. 2, the controller/processor 280 of the UE 120a has an RF exposure manager 281 that is representative of the RF exposure manager 122, according to certain aspects described herein. Although shown at the controller/processor, other components of the UE 120a and BS 110a may be used to perform the operations described herein.

While the UE 120a is described with respect to FIGS. 1 and 2 as communicating with a BS and/or within a network, the UE 120a may be configured to communicate directly with/transmit directly to another UE 120, or with/to another wireless device without relaying communications through a network. In some aspects, the BS 110a illustrated in FIG. 2 and described above may be an example of another UE 120.

NR may utilize orthogonal frequency division multiplexing (OFDM) with a cyclic prefix (CP) on the uplink and downlink. NR may support half-duplex operation using time division duplexing (TDD). OFDM and single-carrier frequency division multiplexing (SC-FDM) partition the system bandwidth into multiple orthogonal subcarriers, which are also commonly referred to as tones, bins, etc. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers. The system bandwidth may also be partitioned into subbands. For example, a subband may cover multiple RBs. NR may support a base subcarrier spacing (SCS) of 15 kHz and other SCSs may be defined with respect to the base SCS (e.g., 30 kHz, 60 kHz, 120 kHz, 240 kHz, etc.).

### Example RF Transceiver

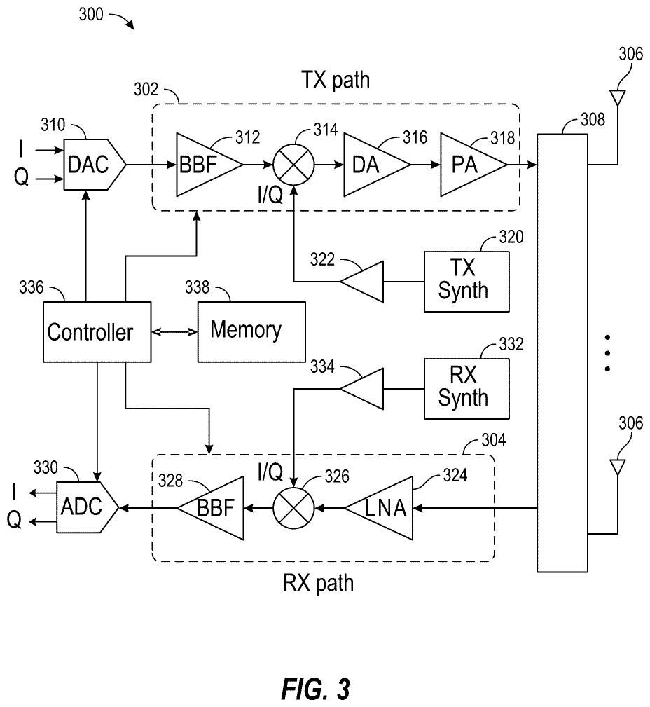

FIG. 3 is a block diagram of an example RF transceiver circuit 300, in accordance with certain aspects of the present disclosure. The RF transceiver circuit 300 includes at least one transmit (TX) path 302 (also known as a transmit chain) for transmitting signals via one or more antennas 306 and at least one receive (RX) path 304 (also known as a receive chain) for receiving signals via the antennas 306. When the TX path 302 and the RX path 304 share an antenna 306, the paths may be connected with the antenna via an interface 308, which may include any of various suitable RF devices, such as a switch, a duplexer, a diplexer, a multiplexer, and the like.

Receiving in-phase (I) or quadrature (Q) baseband analog signals from a digital-to-analog converter (DAC) 310, the TX path 302 may include a baseband filter (BBF) 312, a mixer 314, a driver amplifier (DA) 316, and a power amplifier (PA) 318. The BBF 312, the mixer 314, and the DA 316 may be included in one or more radio frequency integrated circuits (RFICs). The PA 318 may be external to the RFIC(s) for some implementations.

The BBF 312 filters the baseband signals received from the DAC 310, and the mixer 314 mixes the filtered baseband signals with a transmit local oscillator (LO) signal to convert the baseband signal of interest to a different frequency (e.g., upconvert from baseband to a radio frequency). This frequency conversion process produces the sum and difference frequencies between the LO frequency and the frequencies of the baseband signal of interest. The sum and difference frequencies are referred to as the beat frequencies. The beat frequencies are typically in the RF range, such that the signals output by the mixer 314 are typically RF signals, which may be amplified by the DA 316 and/or by the PA 318 before transmission by the antenna 306. While one mixer 314 is illustrated, several mixers may be used to upconvert the filtered baseband signals to one or more intermediate frequencies and to thereafter upconvert the intermediate frequency signals to a frequency for transmission.

The RX path 304 may include a low noise amplifier (LNA) 324, a mixer 326, and a baseband filter (BBF) 328. The LNA 324, the mixer 326, and the BBF 328 may be included in one or more RFICs, which may or may not be the same RFIC that includes the TX path components. RF signals received via the antenna 306 may be amplified by the LNA 324, and the mixer 326 mixes the amplified RF signals with a receive local oscillator (LO) signal to convert the RF signal of interest to a different baseband frequency (e.g., downconvert). The baseband signals output by the mixer 326 may be filtered by the BBF 328 before being converted by an analog-to-digital converter (ADC) 330 to digital I or Q signals for digital signal processing.

Some systems may employ frequency synthesizers with a voltage-controlled oscillator (VCO) to generate a stable, tunable LO with a particular tuning range. Thus, the transmit LO may be produced by a TX frequency synthesizer 320, which may be buffered or amplified by amplifier 322 before being mixed with the baseband signals in the mixer 314. Similarly, the receive LO may be produced by an RX frequency synthesizer 332, which may be buffered or amplified by amplifier 334 before being mixed with the RF signals in the mixer 326.

A controller 336 may direct the operation of the RF transceiver circuit 300, such as transmitting signals via the TX path 302 and/or receiving signals via the RX path 304. The controller 336 may be a processor, a digital signal processor (DSP), an application specific integrated circuit (ASIC), a field programmable gate array (FPGA) or other programmable logic device (PLD), discrete gate or transistor logic, discrete hardware components, or any combination thereof. The memory 338 may store data and program codes for operating the RF transceiver circuit 300. The controller 336 and/or memory 338 may include control logic. In certain cases, the controller 336 and/or memory 338 may determine a time-averaged RF exposure based on transmission power levels applied to the TX path 302 (e.g., certain levels of gain applied to the BBF 312, the DA 316, and/or the PA 318) and/or other TX paths (not shown) to set a transmission power level that complies with an RF exposure limit set by domestic/international regulations and/or international standards, as further described herein.

### Example RF Exposure Compliance

RF exposure may be expressed in terms of a specific absorption rate (SAR), which measures energy absorption by human tissue per unit mass and may have units of watts per kilogram (W/kg). RF exposure may also be expressed in terms of power density (PD), which measures energy absorption per unit area and may have units of milliwatts per square centimeter (mW/cm2). In certain cases, a maximum permissible exposure (MPE) limit in terms of PD may be imposed for wireless communication devices using transmission frequencies above 6 GHz. The MPE limit is a regulatory metric for exposure based on area, e.g., an energy density limit defined as a number, X, watts per square meter (W/m2) averaged over a defined area and time-averaged over a frequency-dependent time window in order to prevent a human exposure hazard represented by a tissue temperature change.

SAR may be used to assess RF exposure for transmission frequencies less than 6 GHz, which cover wireless communication technologies such as 2G/3G (e.g., CDMA), 4G (e.g., LTE), 5G (e.g., NR in 6 GHz bands), IEEE 802.11 (e.g., a/b/g/n/ac), etc. PD may be used to assess RF exposure for transmission frequencies higher than 6 GHZ, which cover wireless communication technologies such as IEEE 802.11ad, 802.11ay, 5G in mmWave bands, etc. Thus, different metrics may be used to assess RF exposure for different wireless communication technologies.

A wireless communication device (e.g., UE 120) may simultaneously transmit signals using multiple wireless communication technologies. For example, the wireless communication device may simultaneously transmit signals using a first wireless communication technology operating at or below 6 GHZ (e.g., 3G, 4G, 5G, 802.11a/b/g/n/ac, etc.) and a second wireless communication technology operating above 6 GHz (e.g., mm Wave 5G in 24 to 60 GHz bands, IEEE 802.11ad or 802.11ay). In certain aspects, the wireless communication device may simultaneously transmit signals using the first wireless communication technology (e.g., 3G, 4G, 5G in sub-6 GHz bands, IEEE 802.11ac, etc.) in which RF exposure is measured in terms of SAR, and the second wireless communication technology (e.g., 5G in 24 to 60 GHz bands, IEEE 802.11ad, 802.11ay, etc.) in which RF exposure is measured in terms of PD. As used herein, sub-6 GHz bands may include frequency bands of 300 MHz to 6,000 MHz in some examples, and may include bands in the 6,000 MHz and/or 7,000 MHz range in some examples.

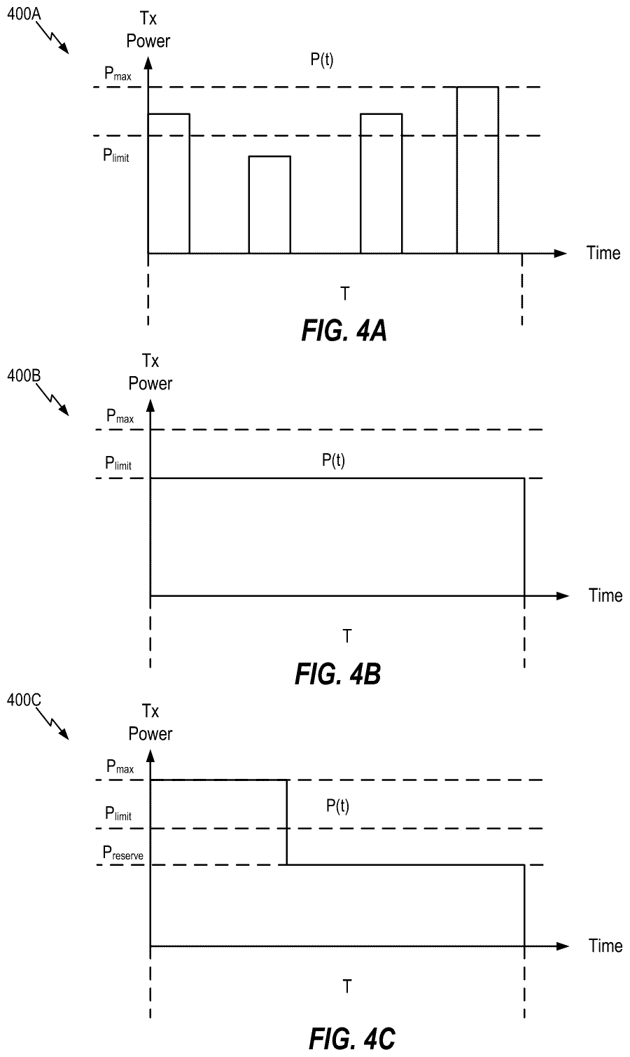

In certain cases, compliance with an RF exposure limit may be performed as a time-averaged RF exposure evaluation within a specified running time window (T) (e.g., 2 seconds for 60 GHz bands, 100 or 360 seconds for bands less than or equal to 6 GHz, etc.) associated with the RF exposure limit. For example, FIG. 4A is a graph 400A of a transmit power over time (P(t)) that varies over the time window (T) associated with the RF exposure limit, in accordance with certain aspects of the present disclosure. As an example, the instantaneous transmit power may exceed a maximum time-averaged transmit power level Pₗᵢₘᵢₜ in certain transmission occasions in the time window (T). In certain cases, the UE may transmit at Pₘₐₓ, which may be the maximum instantaneous transmit power supported by the UE or the maximum instantaneous transmit power the UE is capable of outputting. In certain cases, the UE may transmit at a transmit power less than or equal to Pₗᵢₘᵢₜ in certain transmission occasions. Pₗᵢₘᵢₜ represents the time-averaged threshold in terms of transmit power for the RF exposure limit over the time window (T), and in certain cases, Pₗᵢₘᵢₜ may be referred to as the maximum time-averaged power level or limit, or in terms of exposure, the maximum time-averaged RF exposure level or limit. Pₗᵢₘᵢₜ represents the maximum transmit power the UE can output continuously for the duration of the running time window (T) in compliance with the RF exposure limit as further shown in FIG. 4B. The graph 400A also illustrates gaps between transmission bursts, where the gaps represent periods during which no transmission was sent from the device.

In certain cases, the transmit power may be maintained at the maximum time-averaged transmit power level (e.g., Pₗᵢₘᵢₜ) allowed for RF exposure compliance that enables continuous transmission during the time window. For example, FIG. 4B is a graph 400B of a transmit power over time (P(t)) illustrating an example where the transmit power is limited to Pₗᵢₘᵢₜ, in accordance with certain aspects of the present disclosure. As shown, the UE can transmit continuously at Pₗᵢₘᵢₜ for the duration of the running time window (T) in compliance with the RF exposure limit.

FIG. 4C is a graph 400C of a transmit power over time (P(t)) illustrating a time-averaged mode that provides a reserve power to enable a continuous transmission within the time window (T), in accordance with certain aspects of the present disclosure. As shown, the transmit power may be backed off from the maximum instantaneous power (Pₘₐₓ) to a reserve power (Pᵣₑₛₑᵣᵥₑ) so that the UE can continue transmitting at the lower power (Pᵣₑₛₑᵣᵥₑ) to maintain a continuous transmission during the time window (e.g., maintain a radio connection with a receiving entity). Here, the reserve power Pᵣₑₛₑᵣᵥₑ may be defined as the time-averaged transmit power, for example, so that the UE can transmit at a power level of (Pᵣₑₛₑᵣᵥₑ/duty cycle). As used herein, the reserve power Pᵣₑₛₑᵣᵥₑ may also be referred to as a “control power level” or “control level.” In FIG. 4C, the area between Pₘₐₓ and Pᵣₑₛₑᵣᵥₑ for the time duration of operating with Pₘₐₓ may be equal to the area between Pₗᵢₘᵢₜ and Pᵣₑₛₑᵣᵥₑ for the time window T, such that the area of transmit power (P(t)) in FIG. 4C is equal to the area of Pₗᵢₘᵢₜ for the time window T. Such an area may be considered using 100% of the energy (transmit power or exposure) to remain compliant with the time-averaged RF exposure limit. Without the reserve power Pᵣₑₛₑᵣᵥₑ, the transmitter may transmit at Pₘₐₓ for a portion of the time window with the transmitter turned off for the remainder of the time window to ensure compliance with the time-averaged RF exposure limit. In some aspects, Pᵣₑₛₑᵣᵥₑ is set at a fixed power used to serve for a purpose (e.g., reserving power for certain communications) or at such fixed power plus a margin, as further described herein. The transmit duration at Pₘₐₓ may be referred to as the “burst transmit time” (or “high power duration”). When more margin is available in the future (after T seconds from the start of the burst transmit time), the transmitter may be allowed to transmit at a higher power again (e.g., in short bursts at Pₘₐₓ).

In some aspects, the UE may transmit at a power that is higher than the average power level Pₗᵢₘᵢₜ, but less than Pₘₐₓ in the time-averaged mode illustrated in FIG. 4C. While a single transmit burst is illustrated in FIG. 4C, it will be understood that the UE may instead utilize a plurality of transmit bursts within the time window (T), for example, as described herein with respect to FIG. 4A, where the transmit bursts are separated by periods during which the transmit power is maintained at or below Pᵣₑₛₑᵣᵥₑ. Further, it will be understood that the transmit power of each transmit burst may vary (either within the burst and/or in comparison to other bursts), and that at least a portion of the burst may be transmitted at a power above the maximum average power level (e.g., Pₗᵢₘᵢₜ).

In certain aspects, the UE may transmit at a power less than or equal to a fixed power limit (e.g., Pₗᵢₘᵢₜ) without considering past exposure and/or past transmit powers in terms of a time-averaged RF exposure. For example, the UE may transmit at a power less than or equal to Pₗᵢₘᵢₜ using a look-up table (comprising one or more values of Pₗᵢₘᵢₜ depending on the RF exposure scenario). The look-up table may provide one or more values of Pₗᵢₘᵢₜ depending on the transmit frequency, transmit antenna, radio configuration (single-radio or multi-radio) and/or RF exposure scenario (e.g., a device state index corresponding to head exposure, body or torso exposure, extremity or hand exposure, and/or hotspot exposure) encountered by the UE. Examples of RF exposure scenarios include cases where the UE is emitting RF signals proximate to human tissue, such as a user's head, hand, or body (e.g., torso), or where the UE is being used as a hotspot away from human tissue. Therefore, the RF exposure can be managed as a time-averaged RF exposure evaluation (e.g., illustrated in FIGS. 4A-4C), managed using a look-up table or flat or maximum value, or using another strategy or algorithm, where a particular process of managing the RF exposure may be referred to herein as an “RF exposure control solution” or an “RF exposure control scheme.”

While FIGS. 4A-4C illustrate continuous transmission over a window, occasion, burst, etc., it will be understood that a duty cycle for transmission may be used by, implemented for, or configured for the UE. For example, a transmit power may be zero periodically and maintained at a higher level (e.g., a level as illustrated in FIGS. 4A-4C) during other portions of the time period associated with the duty cycle. In some cases, the wireless device may transmit in bursts, for example, as depicted in FIG. 4A, and the wireless device may have an equivalent duty cycle over the time period associated with the duty cycle. As used herein, the duty cycle of transmission(s) may refer to a portion (e.g., 5 ms) of a specific period (e.g., 500 ms) in which one or more signals are transmitted. In certain cases, the duty cycle may be standardized (e.g., predetermined) with a specific RAT and/or vary over time, for example, due to changes in radio conditions, mobility, and/or user behavior. As an example, certain RATs may specify the uplink duty cycle in the form of a time division duplexing (TDD) configuration, such as a TDD uplink-downlink slot pattern in 5G NR or similar TDD patterns in E-UTRA or UMTS. The duty cycle may correspond to a TDD uplink-downlink (UL-DL) time-domain resource (e.g., slot) pattern as specified by certain wireless communication systems, such as 5G NR or E-UTRA, or may correspond to a specific throttling pattern. In certain aspects, the duty cycle may correspond to the actual duration for past transmissions scheduled, for example, within the TDD UL-DL slot pattern. In certain aspects, the UE may scale transmit power levels based on the duty cycle while preserving a defined control level (e.g., Pᵣₑₛₑᵣᵥₑ) and/or Pₗᵢₘᵢₜ.

A wireless communication device may support multiple radio access technologies, such as 5G NR, E-UTRA (e.g., 4G RAT), UMTS, CDMA (e.g., 2G/3G RAT), IEEE 802.11, Bluetooth, non-terrestrial communications, D2D communications, V2X communications, and/or other communications. In certain cases, the wireless device may have multiple RF exposure control schemes, where each RF exposure control scheme may manage the RF exposure compliance for one or more radios among the RATs. For example, one RF exposure control scheme may use a time-averaged RF exposure limit and RF exposure tracking over time to ensure RF exposure compliance, whereas another RF exposure control scheme may use fixed transmit power limits, which may depend on an exposure scenario, in a look-up table to ensure RF exposure compliance. In other examples, multiple time-averaged RF exposure schemes may be used. In some examples, two or more of the RF exposure schemes operate independent of one another. When a wireless device transitions from using one RF exposure control scheme to using another RF exposure control scheme, the time-averaged RF exposure may be in non-compliance for a short duration (e.g., less than a time window associated with a time-averaged RF exposure limit) if the RF exposure control schemes are not in appropriate communication or if a central manager does not appropriately coordinate between the schemes, for example. In certain cases, the wireless device may allocate the full exposure margin to an RF exposure control scheme when only one RF exposure control scheme is active, and the wireless device may reduce the exposure margin when multiple RF exposure control schemes are active. During (and for a period after) transitions between active RF exposure control schemes, the RF exposure may not be compliance with an RF exposure limit. An RF exposure control scheme may refer to a particular scheme for complying with an RF exposure limit, for example, as depicted in FIGS. 4A-4C, such as a time-averaged RF exposure scheme or a fixed transmit power limit scheme. In some examples, each RF exposure control scheme may manage a respective set of radios based on power or exposure allocations or margins, control information, exposure regulations, etc. assigned to that set of radios.

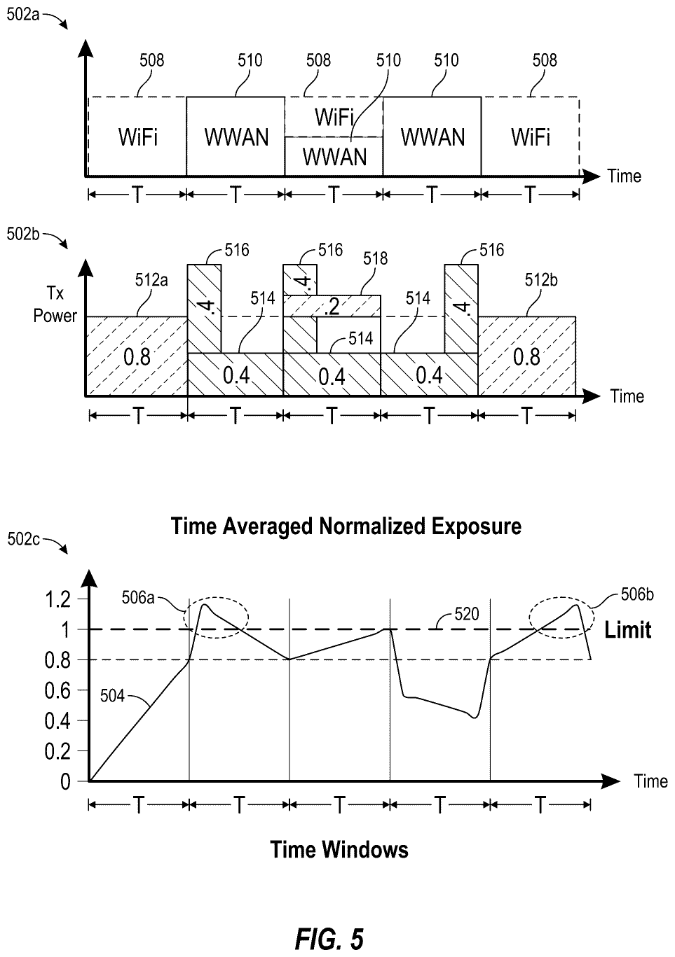

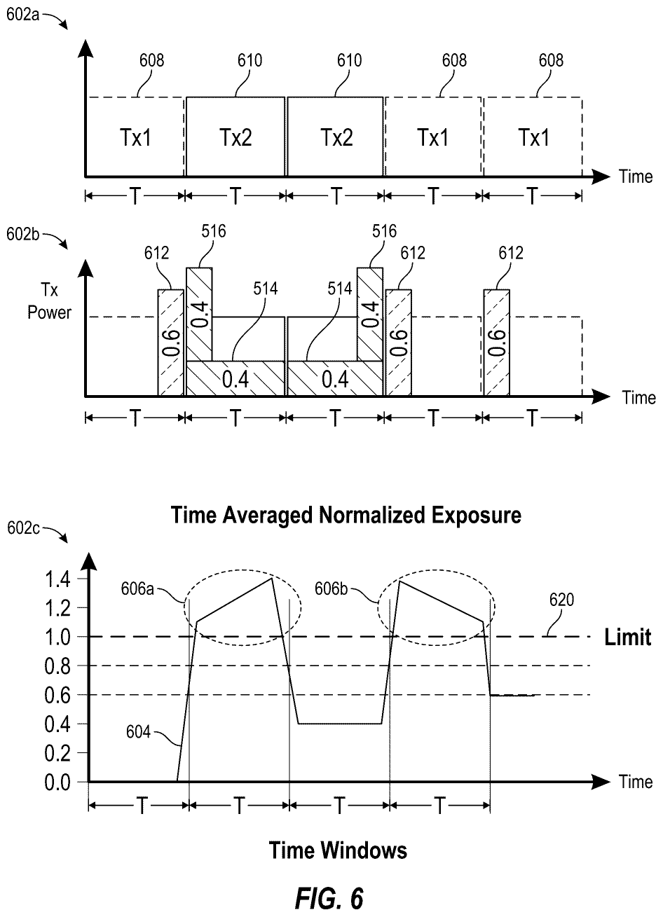

FIGS. 5 and 6 are diagrams illustrating examples of RF exposure control scheme transitions over time. In these examples, the RF exposure may exceed a time-averaged RF exposure time limit due to a transition from one RF exposure control scheme to another RF exposure control scheme.

Referring to FIG. 5, the graph 502a depicts the active states 508, 510 for a first RF exposure control scheme for WLAN RAT(s) (e.g., IEEE 802.11 or WiFi) and a second RF exposure control scheme for WWAN RAT(s) (e.g., 5G NR, E-UTRA, UMTS, CDMA, etc.), respectively, in time windows (T) for a time-averaged RF exposure limit.

The graph 502b depicts the RF exposure margins allocated for each of the RF exposure control schemes in the time windows (T). In this example, the first RF exposure control scheme may operate at up to 80% (0.8) (e.g., a first margin 512a, 512b) of the RF exposure limit when operating alone. The first RF exposure control scheme may not use time averaging, but instead the first RF exposure control scheme may transmit at a transmit power that is less than or equal to a fixed transmit power from a look-up table. The second RF exposure control scheme may use time averaging, and the second RF exposure control scheme may operate at 80% of the RF exposure limit (corresponding to Pₗᵢₘᵢₜ), out of which 40% (e.g., a base reserve 514) is utilized for controlled exposure for the entire time window (e.g., corresponding to Pᵣₑₛₑᵣᵥₑ), and burst transmissions or other transmission traffic may utilize the remaining 40% (e.g., a second margin 516) to transmit up to Pₘₐₓ, when operating alone, for example, as described herein with respect to FIG. 4C. When the first and second RF exposure control schemes operate simultaneously, the first RF exposure control scheme may operate with a reduced exposure margin of 20% (e.g., a third margin 518) such that the RF exposure limit is compliant for simultaneous transmission between these two schemes.

The graph 502c depicts the time-averaged normalized exposure 504 over time with respect to the reserves and margins allocated to the RF exposure control schemes as depicted in graph 502b. In this example, the time-averaged normalized exposure 504 exceeds the RF exposure limit 520 at segments 506a, 506b following transitions between the first and second RF exposure control schemes.

The RF exposure non-compliance could get much worse if both radios employ time-averaging RF exposure control schemes.

Referring to FIG. 6, the graphs 602a, 602b, 602c are the same types of graphs as the graphs 502a, 502b, 502c depicted in FIG. 5, respectively. In this example, the first RF exposure control scheme and the second RF exposure control scheme may be active in the time windows (T) in the active states 608, 610. The first RF exposure control scheme may use a time-averaged RF exposure manager, which may allocate 60% of the RF exposure margin (e.g., a first margin 612) in burst(s) within the time windows (T), for example, at the end of the time window or at the beginning of the time window. Such a scenario may result in RF exposure non-compliance lasting almost a full time window as shown in the graph 602c, where the segments 606a, 606b of the time-averaged normalized exposure 604 exceed the RF exposure limit 620.

To ensure RF exposure compliance for a transition between active RF exposure control schemes, the wireless device may allocate fixed exposure margins to each of the RF exposure control schemes in advance. For example, the wireless device may allocate a first portion of the total RF exposure margin to a first RF exposure control scheme (e.g., an RF exposure manager for one or more WWAN RATs) and a second portion of the total RF exposure margin to a second RF exposure control scheme (e.g., an RF exposure manager for one or more WLAN RATs). Such a scheme may not be efficient, for example, when only one RF exposure control scheme is operating at a time.

As another option, the wireless device may delay transmitting via the radio(s) of the new RF exposure control scheme for a certain duration, such as a time window corresponding to the time-averaged RF exposure limit of the previous RF exposure control scheme. For example, there may be a gap in transmission when transitioning from using one RF exposure control scheme to using another RF exposure control scheme. Another option may include transmitting at a level that is low enough such that compliance is achieved even if the previous scheme(s) had been transmitting at the maximum or using the highest possible burst. Such options, however, may result in an undesirable user experience due to the transmission gap or low transmission power.

### Example RF Exposure Compliance Among Radios

As noted, certain wireless communication devices may have to ensure RF exposure compliance among multiple radios in the wireless communication device. In such wireless communication devices, a primary RF exposure control scheme (RFECS1) may be used to control multiple radios associated with multiple RATs (e.g., WWAN, WLAN, Bluetooth, and satellite) when the primary RF exposure control scheme is online, and a secondary RF exposure control scheme (RFECS2) may be used to control a subset of the multiple radios (e.g., WLAN/Bluetooth) when the primary RF exposure control scheme is offline or otherwise unavailable. However, as noted, transitioning between radios controlled by different RF exposure control schemes may result in temporal non-compliance with an RF exposure limit, such as a total time-averaged RF exposure limit.

Certain aspects of the present disclosure provide various techniques for ensuring RF exposure compliance among radios in a wireless communication device. In particular, certain aspects may enable the wireless communication device to use storage associated with an applications processor (within the wireless communication device) as an intermediate stage between different radios to store various RF exposure information (e.g., RF exposure reports/limits, on-off status of WLAN/Bluetooth radios, and other configuration parameters).

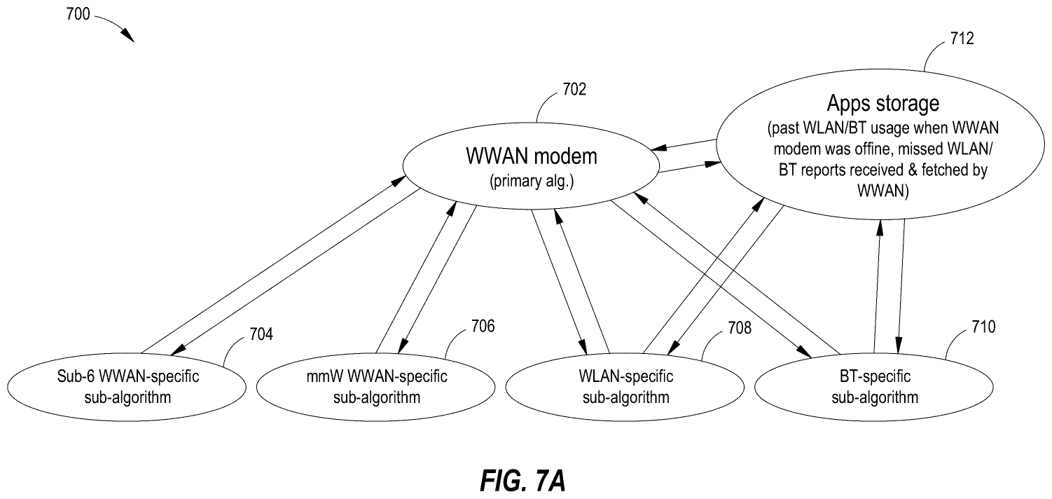

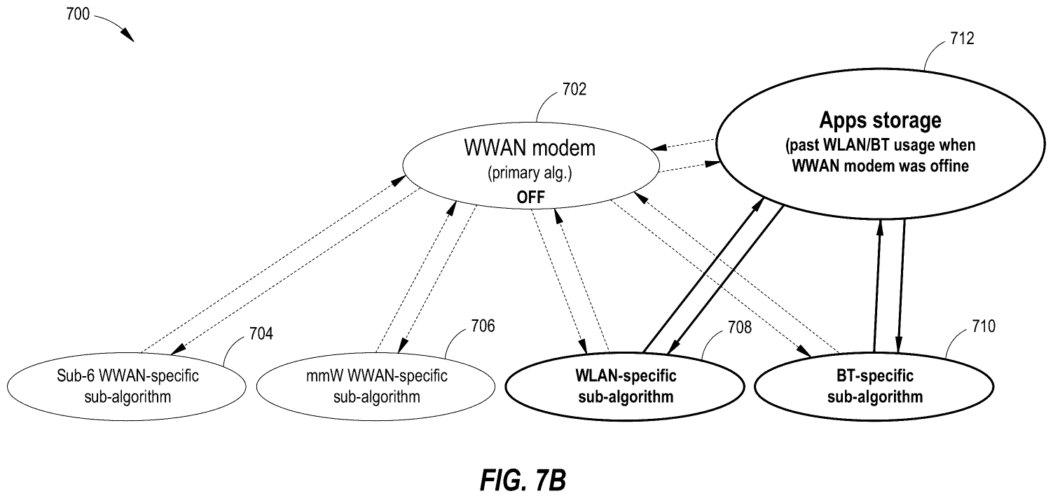

Consider an example architecture 700 illustrated in FIG. 7A and FIG. 7B for exchanging RF exposure information among radios in a wireless communication device, according to certain aspects of the present disclosure. In the example depicted in FIG. 7A, when a WWAN modem is online, an RF exposure control scheme associated with the WWAN modem may serve as a primary RF exposure control scheme 702 for all (or some) of the radios (e.g., a sub 6 GHz WWAN radio, a mmW WWAN radio, a WLAN radio, a Bluetooth radio, a satellite radio, or a combination thereof) and their respective radio-specific sub-algorithms (e.g., a sub-6 GHz WWAN-specific sub-algorithm 704, a mmW WWAN-specific sub-algorithm 706, a WLAN-specific sub-algorithm 708, a Bluetooth-specific sub-algorithm 710, a satellite-specific sub-algorithm (not shown), an RFID-specific sub-algorithm (not shown), or a combination thereof). As alluded to herein, a greater or fewer number of radios and respective radio-specific algorithms than illustrated in FIGS. 7A and 7B may be implemented. For example, a satellite radio may be included, a WLAN radio may be split into sub6 and mmW radios, one or more radios may be configured for operation in frequency range designation FR3 (e.g., being disposed between FR1 and FR2 and/or partially overlapping FR1 and/or FR2) frequencies, etc. Further, such algorithms may not be specific to a single radio, but may manage a plurality of radios (e.g., WLAN and Bluetooth).

Here, the primary RF exposure control scheme 702 and each of the active radio/radio-specific sub-algorithms (e.g., sub 6 GHz WWAN, mmW WWAN, WLAN, Bluetooth, or a combination thereof) may exchange RF exposure information across a communication interface, such as a bus interface. For example, each of the active radios/radio-specific sub-algorithms may send RF exposure information, which includes the radio's RF exposure usage (e.g., transmitted transmission power and transmission power limit), for each time interval to the primary RF exposure control scheme 702. Similarly, the primary RF exposure control scheme 702 may send RF exposure information to each of the active radios/radio-specific sub-algorithms, based on the RF exposure information received from the active radio(s)/radio-specific sub-algorithm(s). In certain aspects, the RF exposure information that is sent to a given radio/radio-specific sub-algorithm each time interval may include an RF exposure limit for the radio for a future time interval, a granted reserve level (or control level) associated with the RF exposure limit for the radio, or a combination thereof.

As shown in FIG. 7A and FIG. 7B, the architecture 700 also includes storage 712 associated with an applications processor in the wireless communication device (referred to herein as “apps storage”). In certain aspects, the “apps storage” is used to store RF exposure information for a subset of the radios/radio-specific sub-algorithms (e.g., WLAN, Bluetooth, or a combination thereof). Here, for example, the WLAN radio and/or Bluetooth radio may send RF exposure information, which includes the respective radio's RF exposure usage (e.g., transmitted transmission power and transmission power limit), on-off information, and other configuration parameters, to the “apps storage” for each time interval.

Additionally, the primary RF exposure control scheme 702 may interact with the “apps storage” to obtain stored RF exposure information from a subset of the radios/radio-specific sub-algorithms (e.g., WLAN, Bluetooth, or a combination thereof). For example, in FIG. 7A, when the primary RF exposure control scheme transitions from being unavailable (e.g., from an offline state) to an online state (e.g., the wireless communication device, and more specifically, the WWAN modem, exits from airplane mode), the primary RF exposure control scheme 702 may perform a one-time operation of receiving past WLAN/Bluetooth RF exposure information (for the duration of time that the primary RF exposure control scheme was unavailable) from the “apps storage.”

As shown in FIG. 7B, when the WWAN modem is offline (e.g., WWAN is in airplane mode or out-of-service), the sub 6 GHz WWAN radio, the mmW WWAN radio, and the primary RF exposure control scheme 702 may be offline or otherwise unavailable. When the primary RF exposure control scheme is unavailable (e.g., offline), each of the active radios/radio-specific sub-algorithms (e.g., the WLAN-specific sub-algorithm 708 and the Bluetooth-specific sub-algorithm 710) may send its RF exposure information for each time interval to the “apps storage.” As noted above, when the primary RF exposure control scheme transitions to an online state, this scheme may fetch the stored RF exposure information (for the duration of time the primary RF exposure control scheme was offline or otherwise unavailable) from the “apps storage.”

Additionally, as shown in FIG. 7B, when the primary RF exposure control scheme is unavailable (e.g., offline), the WLAN-specific sub-algorithm 708 and the Bluetooth-specific sub-algorithm 710 may not receive RF exposure information from the primary RF exposure control scheme 702 for one or more future time intervals. Instead, when the primary RF exposure control scheme 702 is unavailable, the WLAN-specific sub-algorithm 708 and the Bluetooth-specific sub-algorithm 710 may be configured to operate at a transition reserve level (or control level) for a period of time (e.g., one time window of the primary RF exposure control scheme 702) and, after the period of time has elapsed, operate based on a secondary RF exposure control scheme associated with the WLAN/Bluetooth radio.

Note that the architecture 700 depicted in FIG. 7A and FIG. 7B is provided as a reference example architecture for sharing RF exposure information among radios. For example, while the architecture 700 depicts the primary RF exposure control scheme 702 being implemented on the WWAN modem, certain aspects of the present disclosure may allow for implementing the primary RF exposure control scheme 702 elsewhere. For instance, the primary RF exposure control scheme may be implemented in a standalone central controller (in hardware or software), in another radio that supports a different RAT than WWAN (e.g., a WLAN radio), across a set of radios, etc.

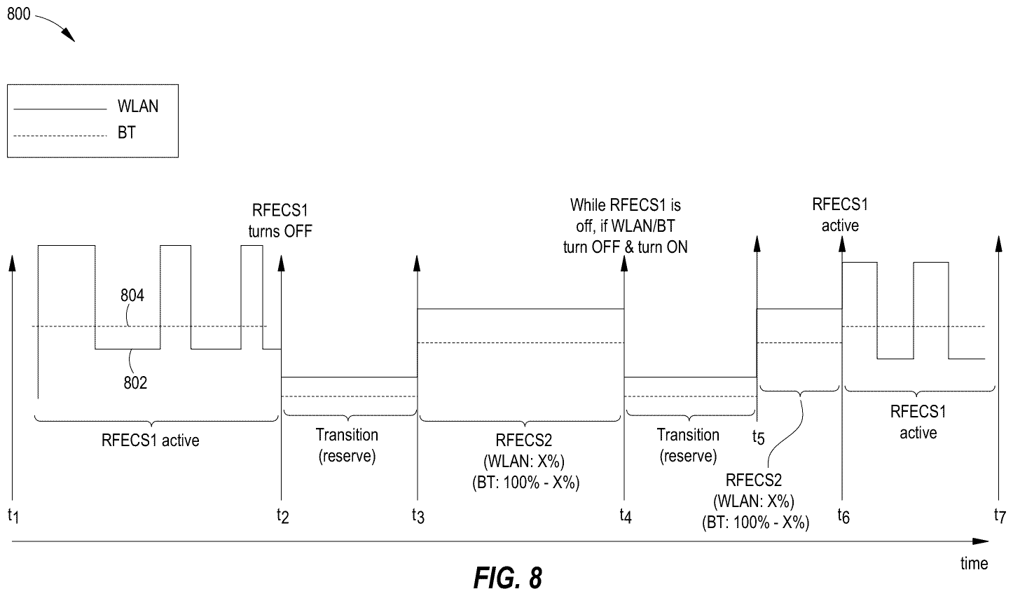

FIG. 8 is a diagram 800 illustrating an example of RF exposure control scheme transitions over time, according to certain aspects of the present disclosure. As shown, when the primary RF exposure control scheme (RFECS1) is online (e.g., t₁ to t₂, t₆ to t₇, etc.), the transmission power behavior of a WLAN radio may be similar to that of a WWAN radio (e.g., the WLAN radio may alternate between high transmission power levels and reserve levels, as illustrated by solid line 802).

For a Bluetooth radio, when the primary RF exposure control scheme is online, the Bluetooth radio may operate at fixed transmission power levels (as opposed to alternating between high transmission power levels and reserve levels), as illustrated by the dotted line 804. The Bluetooth radio may operate at a fixed transmission power level to avoid fluctuations in the quality of certain applications (e.g., audio streaming). In certain aspects, the primary RF exposure control scheme may provide the Bluetooth radio with a fixed reserve level (or control level) that changes depending on the number of active radios. For example, when Bluetooth radio is the standalone radio, then the primary RF exposure control scheme may allocate the Bluetooth radio a “reserve level A=100% of margin,” so that the Bluetooth radio gets a fixed margin equal to 100% for each such time interval. In another example, when Bluetooth radio and one additional radio (e.g., a WWAN radio or a WLAN radio) are active, the primary RF exposure control scheme may allocate the Bluetooth radio a “reserve level B<100% of margin” and allocate the other radio a configured global_reserve (for WWAN and WLAN). When the Bluetooth radio and two other radios are active (e.g., WWAN+WWAN+Bluetooth or WWAN+WLAN+Bluetooth), then the primary RF exposure control scheme may allocate the Bluetooth radio a “reserve level C<reserve level B” and the other radios may split the configured global_reserve based on a split ratio parameter. Note, the Bluetooth reserve levels A, B, and C, the global_reserve parameter for WWAN/WLAN, and the associated split ratio parameters may be configurable by original equipment manufacturers (OEMs) for each antenna group in accordance with a standard.

When the primary RF exposure control scheme transitions from an online state to an offline state (e.g., at t₂ in FIG. 8) or otherwise being unavailable, the WLAN radio/Bluetooth radio may automatically operate at a preconfigured transitional reserve level (or control level) for a predetermined period (e.g., for one time window (T) of the primary RF exposure control scheme, such as t₂ to t₃ in FIG. 8). As illustrated in FIG. 8, this preconfigured transitional reserve level associated with transitions in radio on-off state may be lower than the reserve levels for the WLAN radio/Bluetooth radio while the primary RF exposure control scheme is in the online state. After operating for the predetermined period at the preconfigured transitional reserve level, the WLAN radio/Bluetooth radio may operate based on a secondary RF exposure control scheme (RFECS2) associated with the WLAN radio/Bluetooth radio for at least one time window associated with the secondary RF exposure control scheme (e.g., t₃ to t₄ in FIG. 8). In certain aspects, the WLAN radio and Bluetooth radio may share an RF exposure budget when the WLAN radio and Bluetooth radio are in the same antenna group (e.g., WLAN operates at x % and Bluetooth operates at (100-x) %). In other aspects, the WLAN radio and Bluetooth radio may each operate at 100% RF exposure budget when the WLAN radio and Bluetooth radio are in different antenna groups.

While the primary RF exposure control scheme (RFECS1) is unavailable (e.g., offline), if the WLAN radio/Bluetooth radio transitions from being unavailable (e.g., from the offline state) to the online state (e.g., at t₄ in FIG. 8), then the WLAN radio/Bluetooth radio may (again) operate at its respective preconfigured transitional reserve level for the predetermined period (e.g., for one time-window of the primary RF exposure control scheme, such as t₄ to t₅ in FIG. 8). Note that, because the WLAN radio and Bluetooth radio can turn on/off independently, the WLAN radio and Bluetooth radio may operate based on independent times. Thus, while FIG. 8 depicts the WLAN radio and Bluetooth radio starting operation at their respective preconfigured reserve levels at the same time at t₄, the WLAN radio and Bluetooth radio may start operating at their respective preconfigured reserve levels at different times. Similarly, while FIG. 8 depicts the WLAN radio and Bluetooth radio starting operation based on their respective secondary RF exposure control schemes (RFECS2) at the same time at t₃, the WLAN radio and Bluetooth radio may start operating based on their respective secondary RF exposure control schemes at different times. In certain aspects, if the WLAN radio/Bluetooth radio know when the primary RF exposure control scheme turned off (e.g., the on-off information of the primary RF exposure control scheme may be stored in the “apps storage”), then the WLAN radio/Bluetooth radio may be able to avoid at least a portion (or even all) of the operation at the preconfigured transitional reserve level (e.g., from t₂ to t₃, from t₄ to t₅, etc.).

When the primary RF exposure control scheme (RFECS1) transitions from being unavailable (e.g., from offline) to online (e.g., at to in FIG. 8), the primary RF exposure control scheme may obtain the past RF exposure information of the WLAN radio/Bluetooth radio for the duration that the primary RF exposure control scheme was unavailable from the “apps storage.” With this past RF exposure information, the primary RF exposure control scheme may control operation of the various radios while ensuring time-averaged RF exposure compliance.

As noted above, there may be a misalignment in the sleep/wakeup cycles for different chipsets (e.g., WWAN, WLAN, Bluetooth, etc.). Since the primary RF exposure control scheme (in the WWAN modem) and WLAN radio/Bluetooth radio may be in different chipsets, each radio may have different sleep/wakeup cycles. As a result, in certain instances, the RF exposure reporting from WLAN radio/Bluetooth radio to the primary RF exposure control scheme as well as the transmission of RF exposure information from the primary RF exposure control scheme to the WLAN radio/Bluetooth radio may not go through.

To address this, in certain aspects, when the primary RF exposure control scheme (RFECS1) sends RF exposure limit(s) to the WLAN radio/Bluetooth radio at each time interval (e.g., every 0.5 seconds), the primary RF exposure control scheme may also send a granted reserve level (or control level) associated with the RF exposure limit. In this manner, if the WLAN radio/Bluetooth radio do not receive an RF exposure limit from the primary RF exposure control scheme in a first predetermined amount of time (e.g., 0.5 seconds), the WLAN radio/Bluetooth radio may fall back to the granted reserve level for a second predetermined amount of time (e.g., 5 seconds). If the WLAN radio/Bluetooth radio does not receive an RF exposure limit after the second predetermined amount of time has elapsed, then the WLAN radio/Bluetooth radio may assume that the primary RF exposure control scheme has transitioned to being unavailable (e.g., transitioned to an offline state). At this point in time, the WLAN radio/Bluetooth radio may go to a transition period and operate at a preconfigured reserve level for one time window of the primary RF exposure control scheme followed by operation at a transmission level set by a second RF exposure control scheme.

Additionally, as noted, the primary RF exposure control scheme may not receive RF exposure reports from the WLAN radio/Bluetooth radio every time interval (e.g., every 0.5 seconds or less) due to misalignment in sleep/wakeup cycles. In these cases, if the primary RF exposure control scheme does not acknowledge to the WLAN radio/Bluetooth radio that the primary RF exposure control scheme received the WLAN/Bluetooth exposure report every time interval (e.g., every 0.5 seconds or less), then the WLAN radio/Bluetooth radio may keep accumulating the reports (e.g., for a number of time intervals) and keep trying to send these reports to the primary RF exposure control scheme. For example, if the primary RF exposure control scheme has not acknowledged for 2 seconds, then the WLAN radio/Bluetooth radio may keep accumulating the past 2 seconds of reports (e.g., the previous four intervals' worth of reports). When the primary RF exposure control scheme does acknowledge, the primary RF exposure control scheme may receive all 2 seconds' worth of the transmitted WLAN/Bluetooth exposure reports.

In another example, if the primary RF exposure control scheme has not acknowledged for more than the stipulated time of the granted reserve (e.g., 5 seconds), then the WLAN radio/Bluetooth radio may store the exposure report history for this amount of time (e.g., 5 seconds) in the “apps storage.” The WLAN radio/Bluetooth radio may then assume that the primary RF exposure control scheme has transitioned to offline state, transmit at the preconfigured reserve level for the predetermined period (e.g., one time window of the primary RF exposure control scheme), and continue storing reports in the “apps storage” every time interval (e.g., 5 seconds) until a new RF exposure limit is received from the primary RF exposure control scheme.

Similarly, in certain aspects, the primary RF exposure control scheme may assume that the WLAN radio/Bluetooth radio has transmitted according to a previously sent RF exposure limit (e.g., 0.5 seconds of RF exposure limit+5 seconds of granted reserve level) for the duration of time the primary RF exposure control scheme did not receive an RF exposure report(s). For example, if the primary RF exposure control scheme did not receive reports for 2 seconds, then the primary RF exposure control scheme may assume that 0.5 seconds of exposure limit and 1.5 seconds of granted reserve level that was last acknowledged by the WLAN radio/Bluetooth radio has been used. Otherwise, in this example, if the primary RF exposure control scheme assumes a zero exposure usage for the WLAN radio/Bluetooth radio for the past 2 seconds, then the primary RF exposure control scheme may allocate the 2 seconds' worth of exposure margin to the active WWAN radio, resulting in a potential over-usage of RF exposure as both WWAN and WLAN/Bluetooth may be unknowingly using the same budget. In such as case, by the time the primary RF exposure control scheme does receive the 2 seconds' worth of exposure reports from the WLAN radio/Bluetooth radio as well as the WWAN exposure report, the primary RF exposure control scheme may be in non-compliance of an RF exposure limit, resulting in a device crash and/or drop of one or more radio links.

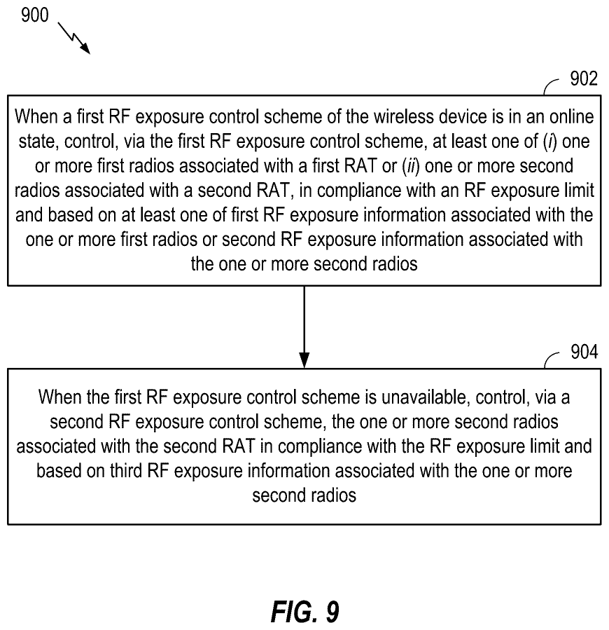

FIG. 9 is a flow diagram illustrating example operations 900 for wireless communication, in accordance with certain aspects of the present disclosure. The operations 900 may be performed, for example, by a wireless device (e.g., the UE 120a in the wireless communication network 100). The operations 900 may be implemented as software components that are executed and run on one or more processors (e.g., controller/processor 280 of FIG. 2). Further, the transmission and/or reception of signals by the wireless device in the operations 900 may be enabled, for example, by one or more antennas (e.g., antennas 252 of FIG. 2). In certain aspects, the transmission and/or reception of signals by the wireless device may be implemented via a bus interface of one or more processors (e.g., controller/processor 280) obtaining and/or outputting signals for reception or transmission.

The operations 900 may optionally begin, at block 902, where, when a first RF exposure control scheme (e.g., primary RF exposure control scheme) of the wireless device is in an online state, the wireless device controls, via the first RF exposure control scheme, at least one of (i) one or more first radios associated with a first RAT (e.g., WWAN radio) or (ii) one or more second radios associated with a second RAT (e.g., WLAN radio, Bluetooth radio, or a combination thereof), in compliance with an RF exposure limit (e.g., total time-averaged RF exposure limit) and based on at least one of (a) first RF exposure information associated with the one or more first radios or (b) second RF exposure information associated with the one or more second radios. In certain aspects, the first RF exposure information may be obtained from the one or more first radios, and the second RF exposure information may be obtained from the one or more second radios.

At block 904, when the first RF exposure control scheme is unavailable (e.g., in in an offline state or a sleep cycle, such as a deep or frequent sleep cycle), the wireless device controls, via a second RF exposure control scheme (e.g., secondary RF exposure control scheme), the one or more second radios associated with the second RAT in compliance with the RF exposure limit and based on third RF exposure information associated with the one or more second radios. In certain aspects, the third RF exposure information may be obtained from a storage location associated with an applications processor in the wireless device (e.g., the storage 712, referred to herein as the “apps storage”).

In certain aspects, controlling, via the second RF exposure control scheme, the one or more second radios (in block 904) may include: (i) determining a first transmission power level for the one or more second radios that applies during a first time window, based on a first control level (e.g., preconfigured reserve level) for the one or more second radios; and (ii) determining a second transmission power level for the one or more second radios that applies for a second time window subsequent to the first time window, based on at least one of a second control level (e.g., granted reserve level) or a first RF exposure limit (e.g., granted RF exposure limit), for the one or more second radios that applies during the second time window. The first time window may be a preconfigured time window associated with the first RF exposure control scheme in the online state. The second time window may be associated with the second RF exposure control scheme. The first control level may be lower than the second control level.

In certain aspects, controlling, via the first RF exposure control scheme, at least one of the one or more first radios or the one or more second radios (in block 902) may include: (i) determining a first transmission power level for the one or more first radios that applies during a first time interval (e.g., WWAN independent time window), based on at least one of a first control level (e.g., granted reserve level) or a first RF exposure limit (e.g., granted RF exposure limit) for the one or more first radios; (ii) determining a second transmission power level for the one or more second radios that applies during a second time interval (e.g., WLAN/Bluetooth independent time window), based on at least one of a second control level (e.g., granted reserve level) or a second RF exposure limit (e.g., granted RF exposure limit) for the one or more second radios; or (iii) a combination thereof. In certain aspects, the second transmission power level may be a fixed transmission power level for the second time interval (e.g., in the case where the second radio is a Bluetooth radio).

In certain aspects, the operations 900 may further include, when the first RF exposure control scheme transitions from being unavailable (e.g., from the offline state) to the online state, the wireless device obtaining the second RF exposure information associated with the one or more second radios from a storage location associated with an applications processor in the wireless device (e.g., the storage 712, referred to herein as the “apps storage”). In such aspects, the second RF exposure information may correspond to a time interval in which the first RF exposure control scheme was unavailable (e.g., in the offline state).

In certain aspects, the operations 900 may further include, when the first RF exposure control scheme is in the online state and upon determining that a predetermined amount of time has elapsed since obtaining the second RF exposure information, the wireless device controlling the one or more second radios based on a transmission power limit previously determined for the one or more second radios.

In certain aspects, the operations 900 may further include determining an updated transmission power limit for the one or more second radios upon obtaining the second RF exposure information.

### Example Communication Performance Optimizations with RF Exposure Compliance Among Radios

Aspects of the present disclosure provide apparatus, methods, processing systems, and computer-readable mediums for optimizing (or at least improving) communication performance of a wireless communication device while ensuring RF exposure compliance among radios in the wireless communication device. The wireless communication device may be a multi-tech/multi-band wireless communication device.

As noted above, in certain aspects, a wireless communication device may use an applications processor (and associated “apps storage”) (or, in general, any storage/processor separate from the primary RF exposure control scheme) within the wireless communication device as an intermediate stage (i.e., an intermediary) between the WWAN modem and the WLAN/Bluetooth modem, since WWAN/WLAN/Bluetooth have independent sleep/wakeup cycles. Using the applications processor as an intermediate stage may allow for: (i) storing on-off radio status of WLAN/Bluetooth radios and sending this information to the primary RF exposure control scheme as well as to the WLAN/Bluetooth radios (so that when the primary RF exposure control scheme is offline or otherwise unavailable, the WLAN/Bluetooth radios can operate at a higher transmission power level depending on whether the other Bluetooth/WLAN radio is on or off); (ii) storing missed WLAN/Bluetooth reports (due to misalignment in sleep cycles) sent to the primary RF exposure control scheme so that the primary RF exposure control scheme can fetch the reports periodically; (iii) storing WLAN/Bluetooth reports when the primary RF exposure control scheme is offline or otherwise unavailable for extended periods (e.g., in airplane mode) so that the reports can be shared; (iv) relaying electronic file system (EFS) configuration parameters from the WWAN modem to the WLAN/Bluetooth radios; (v) indicating the transmit scenario including the device state index (DSI) (e.g., representing device next to head, next to body, in hotspot mode, etc.) to all radios (e.g., WWAN, WLAN, Bluetooth, satellite, etc.); (vi) relaying airplane mode status to WLAN/Bluetooth; and/or (vii) relaying country location from the WWAN modem to the WLAN/Bluetooth radios (so these radios can apply correct transmission power limits (Pₗᵢₘᵢₜₛ) for time-averaged RF exposure based on a local regulator's RF exposure compliance specifications), as illustrative, non-limiting examples.

However, one potential drawback with using the applications processor as an intermediate stage among radios is that waking up the applications processor can consume a significant amount of battery power. That is, application processor wakeups may be significant battery consumption events as each wakeup may last for hundreds of milliseconds. Accordingly, it may be desirable to provide techniques for optimizing, or at least decreasing, the battery power consumption when using an applications processor to ensure RF compliance among radios in a wireless communication device.

Certain aspects described herein provide techniques that allow the wireless communication device to transfer (or move) a primary RF exposure control scheme into any radio/modem/chipset or storage/processor/subsystem of the wireless device. That is, the primary RF exposure control scheme can be implemented on the WWAN radio (if active), the WLAN radio (if active), any active storage/processor/subsystem (e.g., an applications processor), or the Bluetooth radio (if active), as illustrative, non-limiting examples. For ease of description, it is to be understood that “applications processor” as used herein can also mean a suitable intermediate stage between different types of radios, of which the applications processor is one example. For example, functionality described herein with respect to an applications processor may alternatively or additionally be performed by another radio or processor.

Consider, for example, the architecture 700 depicted in FIG. 7A and FIG. 7B. Here, when the WWAN modem is online, the RF exposure control scheme associated with the WWAN modem may serve as the primary RF exposure control scheme for all (or some) of the radios (e.g., the sub 6 GHz WWAN radio, the mmW WWAN radio, the WLAN radio, the Bluetooth radio, the satellite radio, or a combination thereof) and their respective radio-specific sub-algorithms (e.g., the sub-6 GHz WWAN-specific sub-algorithm 704, the mmW WWAN-specific sub-algorithm 706, the WLAN-specific sub-algorithm 708, the Bluetooth-specific sub-algorithm 710, a satellite-specific sub-algorithm (not shown), an RFID-specific sub-algorithm (not shown), or a combination thereof). As noted, the primary RF exposure control scheme and each of the active radios/radio-specific sub-algorithms may exchange RF exposure information across a communication interface, such as a bus interface. For example, each of the active radios/radio-specific sub-algorithms may send RF exposure information, which includes the radio's RF exposure usage (e.g., transmitted transmission power and transmission power limit), for each time interval, to the primary RF exposure control scheme. Similarly, the primary RF exposure control scheme may send RF exposure information to each of the active radios/radio-specific sub-algorithms, based on the RF exposure information received from the active radio(s)/radio-specific sub-algorithm(s). Additionally, the primary RF exposure control scheme may control the transmission power level(s) of active radio(s) using various techniques described herein in order to maintain RF compliance across the radios.

When the WWAN modem transitions from the online state to being unavailable (e.g., to an offline state), certain aspects described herein may move or transfer the primary RF exposure control scheme's operation to a secondary RF exposure control scheme. The secondary RF exposure control scheme may be associated with the WLAN/Bluetooth radio, another radio that supports a different RAT, or any storage/processor/subsystem (e.g., applications processor) of the wireless device. Transferring the primary RF exposure control scheme's operation to the secondary RF exposure control scheme may include transferring configuration information associated with the primary RF exposure control scheme to the secondary RF exposure control scheme. Such configuration information may include (i) on-off information for all (or some of) the radios, (ii) one or more transmission power control algorithms for all (or some of) the radios, (iii) one or more parameters associated with an RF exposure limit, (iv) EFS configuration parameters (e.g., antenna groupings, reserve levels, maximum time-averaged transmit power levels, etc.), and/or (v) past exposure history in one or more time windows for all (or some) antenna groups of the wireless communication device, as illustrative, non-limiting examples. In general, the configuration information may include any set of parameters that enables the secondary RF exposure control scheme to perform one or more operations of the primary RF exposure control scheme. The configuration information may be obtained from at least one storage location associated with the primary RF exposure control scheme.

After the configuration information is transferred, the secondary RF exposure control scheme may continue the primary RF exposure control scheme's operation for all (or some) of the radios. For example, the secondary RF exposure control scheme and each of the active radios/radio-specific sub-algorithms (e.g., sub 6 GHz WWAN, mmW WWAN, WLAN, Bluetooth, or a combination thereof) may exchange RF exposure information across a communication interface, such as a bus interface. For example, each of the active radios/radio-specific sub-algorithms may send RF exposure information, which includes the radio's RF exposure usage (e.g., transmitted transmission power and transmission power limit), for each time interval, to the secondary RF exposure control scheme. Similarly, the secondary RF exposure control scheme may send RF exposure information to each of the active radios/radio-specific sub-algorithms, based on the RF exposure information received from the active radio(s)/radio-specific sub-algorithm(s). Additionally, the secondary RF exposure control scheme may control the transmission power level(s) of active radio(s) using various techniques described herein in order to maintain RF compliance across the radios.

By transferring operation of the primary RF exposure control scheme to another secondary RF exposure control scheme associated with another (active) radio/chipset/modem or (active) storage/processor/subsystem, certain aspects can enable the wireless communication device to reduce battery power consumption by avoiding wakeups of an inactive radio/chipset/modem or (inactive) storage/processor/subsystem, thereby improving communication performance of the wireless communication device while ensuring RF exposure compliance among the radios of the wireless communication device.

Note that the architecture 700 depicted in FIG. 7A and FIG. 7B is provided as a reference example architecture for sharing RF exposure information among radios. For example, while the architecture 700 depicts the primary RF exposure control scheme being implemented on the WWAN modem, aspects of the present disclosure may allow for implementing the primary RF exposure control scheme elsewhere. For instance, the primary RF exposure control scheme may be implemented in a standalone central controller (in hardware or software), in another radio that supports a different RAT than WWAN (e.g., WLAN), across a set of radios, etc. Similarly, note that the radios/radio-specific sub-algorithms (e.g., WWAN, WLAN, Bluetooth) and applications processor depicted in FIG. 7A and FIG. 7B are provided as reference examples of “subsystems” of the wireless device. In certain cases, such a “subsystem” may be representative of an isolated chipset of the wireless device. In other cases, such a “subsystem” may generally refer to any means of the wireless device that performs certain RF exposure operations related to storage and/or computations, controls one or more radio technology transmissions, or a combination thereof.

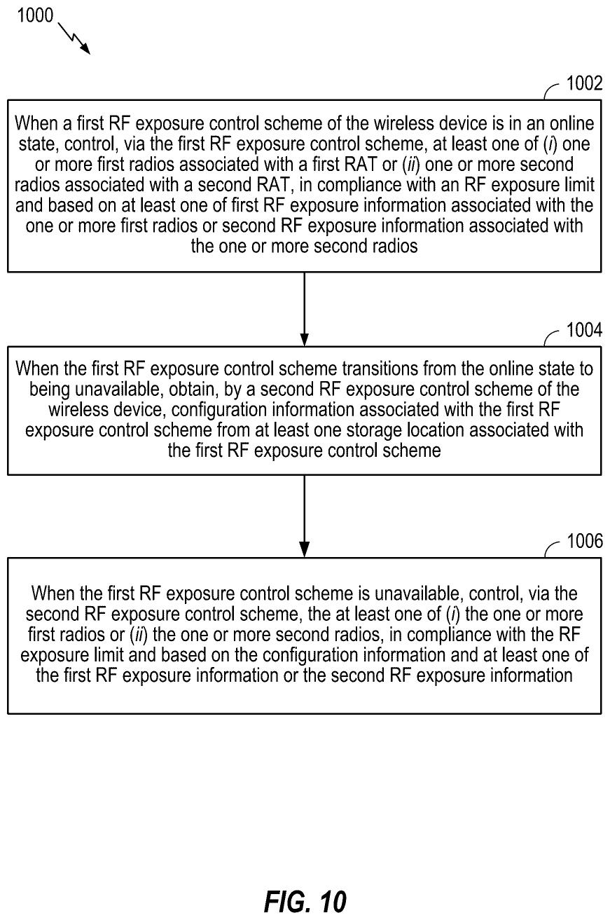

FIG. 10 is a flow diagram illustrating example operations 1000 for wireless communication, in accordance with certain aspects of the present disclosure. The operations 1000 may be performed, for example, by a wireless device (e.g., the UE 120a in the wireless communication network 100). The operations 1000 may be implemented as software components that are executed and run on one or more processors (e.g., controller/processor 280 of FIG. 2). Further, the transmission and/or reception of signals by the wireless device in the operations 1000 may be enabled, for example, by one or more antennas (e.g., antennas 252 of FIG. 2). In certain aspects, the transmission and/or reception of signals by the wireless device may be implemented via a bus interface of one or more processors (e.g., controller/processor 280) obtaining and/or outputting signals for reception or transmission.

The operations 1000 may optionally begin, at block 1002, where, when a first RF exposure control scheme (e.g., primary RF exposure control scheme (RFECS1)) of the wireless device is in an online state, the wireless device controls, via the first RF exposure control scheme, at least one of (i) one or more first radios associated with a first RAT (e.g., a WWAN radio) or (ii) one or more second radios associated with a second RAT (e.g., a WLAN radio, a Bluetooth radio, or a combination thereof), in compliance with an RF exposure limit (e.g., total time-averaged RF exposure limit) and based on at least one of first RF exposure information associated with the one or more first radios or second RF exposure information associated with the one or more second radios the wireless device. The first RF exposure information may be obtained from the one or more first radios, and the second RF exposure information may be obtained from the one or more second radios.

In certain aspects, controlling, via the first RF exposure control scheme, the at least one of the one or more first radios or the one or more second radios (in block 1002) may include: (a) determining a first transmission power level for the one or more first radios that applies during a first time interval, based on at least one of a first control level (e.g., a preconfigured reserve level) or a first RF exposure limit for the one or more first radios; (b) determining a second transmission power level for the one or more second radios that applies during a second time interval, based on at least one of a second control level (e.g., a granted reserve level) or a second RF exposure limit (e.g., a granted RF exposure limit) for the one or more second radios; or (c) a combination thereof.

At block 1004, when the first RF exposure control scheme transitions from the online state to being unavailable, the wireless device obtains, via a second RF exposure control scheme (e.g., secondary RF exposure control scheme) of the wireless device, configuration information associated with the first RF exposure control scheme from at least one storage location associated with the first RF exposure control scheme. The configuration information may include at least one of: (a) on-off information associated with the one or more first radios and the one or more second radios, (b) one or more transmission power control algorithms for the one or more first radios and the one or more second radios, or (c) one or more parameters associated with the RF exposure limit.

At block 1006, when the first RF exposure control scheme is unavailable, the wireless device controls, via the second RF exposure control scheme, the at least one of (i) the one or more first radios or (ii) the one or more second radios, in compliance with the RF exposure limit and based on the configuration information and at least one of the first RF exposure information or the second RF exposure information. The first RF exposure information may be obtained from the one or more first radios, and the second RF exposure information may be obtained from the one or more second radios.

In certain aspects, controlling, via the second RF exposure control scheme, the at least one of the one or more first radios or the one or more second radios (in block 1002) may include: (a) determining a first transmission power level for the one or more first radios that applies during a first time interval, based on at least one of a first control level (e.g., preconfigured reserve level) or a first RF exposure limit for the one or more first radios; (b) determining a second transmission power level for the one or more second radios that applies during a second time interval, based on at least one of a second control level (e.g., granted reserve level) or a second RF exposure limit (e.g., granted RF exposure limit) for the one or more second radios; or (c) a combination thereof.

In certain techniques described herein may allow a storage/processor/subsystem (e.g., applications processor or other intermediary) within the wireless communication device that is external to the primary RF exposure control scheme to operate as the primary RF exposure control scheme as opposed to solely operating as an intermediate stage between radios of the wireless communication device. Using the applications processor as a reference example of an external storage/processor/subsystem, the applications processor may perform one or more operations of the primary RF exposure control scheme for all (or some) of the active radios (e.g., WLAN/Bluetooth radios) of the wireless communication device when the primary RF exposure control scheme is in the offline state or otherwise unavailable. For example, the applications processor may implement a secondary RF exposure control scheme for all (or some) of the active radios of the wireless communication device when the primary RF exposure control scheme is in the offline state or otherwise unavailable.

In some cases, the secondary RF exposure control scheme (e.g., implemented via the applications processor) may obtain, from the primary RF exposure control scheme, an indication of (i) a control level (e.g., transition reserve level) that applies during a first time window (e.g., t₂ to t₃ illustrated in FIG. 8) that is associated with the second RF exposure control scheme, (ii) an RF exposure limit (e.g., granted RF exposure limit) that applies during a second time window (subsequent to the first time window) (e.g., t₃ to t₄ illustrated in FIG. 8) that is associated with the second RF exposure control scheme, or (iii) a combination thereof. The secondary RF exposure control scheme may obtain the indication of at least one of the control level or the RF exposure limit from the primary RF exposure control scheme prior to the primary RF exposure control scheme being unavailable (e.g., prior to entering the inactive state). For example, the primary RF exposure control scheme may determine and provide at least one of the control level or the RF exposure limit to the secondary RF exposure control scheme during a third time window (e.g., t₁ to t₂ illustrated in FIG. 8) (prior to a start of the first time window) in which the primary RF exposure control scheme was in the online state. In some cases, prior to the primary RF exposure control scheme being unavailable (e.g., prior to entering the inactive state), the primary RF exposure control scheme may provide the secondary RF exposure control scheme an indication of (a) a first control level of the WLAN radio in standalone conditions, (b) a second control level of the Bluetooth radio in standalone conditions, (c) a third control level of the WLAN radio in simultaneous operation with the Bluetooth radio, and/or (d) a fourth control level of the Bluetooth radio in simultaneous operation with the WLAN radio. Note, the secondary RF exposure control scheme may know when the primary RF exposure control scheme turned off (e.g., the on-off information of the primary RF exposure control scheme may be stored in or otherwise accessible to the applications processor).

In certain aspects, as opposed to the control level(s) (e.g., transition reserve level) having a fixed (or pre-configured) value, the value of the control level(s) may be dynamically determined by the primary RF exposure control scheme during the third time window (e.g., t₁ to t₂ illustrated in FIG. 8). For example, the primary RF exposure control scheme may determine a value of the control level(s), based on the amount of RF exposure associated with the primary RF exposure control scheme that has been consumed in the third time window. For instance, if the past RF exposure in the third time window is equal to zero, then the control level allocated for the second time window may be 100% for the WLAN/Bluetooth radios (e.g., assuming the WLAN/Bluetooth radios are in standalone conditions and operate in the same regulatory time window). In general, the control level that applies during the second time window may be determined according to the following expression:

$$control level = sustainable reserve level of primary RF exposure control scheme + unused high power margin portion during third time window \qquad ( 1 )$$

In certain aspects, at least one of (i) the value of the control level(s) or (ii) the value of the RF exposure limit(s) may be based on a respective power state of the active radio(s). For example, when the secondary RF exposure control scheme is performing one or more operations of the primary RF exposure control scheme, the secondary RF exposure control scheme may be aware of the power state (e.g. ON/OFF status) of each of the active radios (e.g., the WLAN/Bluetooth radios). In such cases, as opposed to allocating each of the active radios a reserve and/or RF exposure limit based on a fixed split ratio (e.g., WLAN operates at x % and Bluetooth operates at (100−x) %), the secondary RF exposure control scheme may determine to allocate a given active radio all of the control level (e.g., control level=100%) and/or all of the RF exposure limit (e.g., RF exposure limit=100%) when the active radio is the standalone active radio (e.g., there is no other radio actively transmitting). In some examples, if the WLAN radio and Bluetooth radio operate in the same time window (e.g., International Commission on Non-Ionizing Radiation Protection (ICNIRP) operating in 360 seconds), then the first control level=second control level=third control level+fourth control level. If the WLAN radio and Bluetooth radio operate in different time windows (e.g., the time window for Bluetooth may be 100 seconds and the time window for WLAN may be 30 seconds), then the first control level may not be equal to the second control level, the first control level may not be equal to the sum of the third control level and the fourth control level, and the second control level may not be equal to the sum of the third control level and the fourth control level. In such cases where the WLAN radio and Bluetooth radio operate in different time windows, the primary RF exposure control scheme may pre-compute and provide the values for the first control level, the second control level, the third control level, and the fourth control level to the secondary RF exposure control scheme.

The secondary RF exposure control scheme (implemented via the applications processor) may control all (or some) of the active radios by controlling the transmission power level(s) of the active radio(s) using various techniques described herein in order to maintain RF compliance across the radios. For example, the secondary RF exposure control scheme may determine a first transmission power level that applies during the first time window (e.g., t₂ to t₃ illustrated in FIG. 8) based on the control level, determine a second transmission power level that applies during the second time window (e.g., t₃ to t₄ illustrated in FIG. 8) based on the RF exposure limit, or a combination thereof.

In certain aspects, the secondary RF exposure control scheme (implemented via the applications processor) may determine whether to send at least one of the first transmission power level (including the control level) or the second transmission power level (including the RF exposure limit), based on when the primary RF exposure control scheme became unavailable (e.g., entered the offline state). As noted, the secondary RF exposure control scheme may operate according to an independent timer and be aware of when the primary RF exposure control scheme turned off. The secondary RF exposure control scheme may use such information to inform the active radio(s) (e.g., WLAN/Bluetooth radios) how long the radios have to operate with the control level before switching to operating with the RF exposure limit.

In one example, if the secondary RF exposure control scheme determines that the primary RF exposure control scheme became unavailable (e.g., entered the offline state) during the first time window (e.g., t₂ to t₃ illustrated in FIG. 8), then the secondary RF exposure control scheme may send, to the active radios: (i) the control level (including the first transmission power level), (ii) an indication of the first time window in which the control level applies, (iii) an indication of a remaining amount of time within the first time window in which the control level applies, (iv) the RF exposure limit (including the second transmission power level), (v) an indication of the second time window in which the RF exposure limit applies, or (vi) a combination thereof.

In another example, if the secondary RF exposure control scheme determines that the primary RF exposure control scheme became unavailable (e.g., entered the offline state) during the second time window (e.g., t₃ to t₄ illustrated in FIG. 8), then the secondary RF exposure control scheme may send, to the active radios, the RF exposure limit (including the second transmission power level). For instance, if the primary RF exposure control scheme was unavailable (e.g., in the offline state) for more than one time window prior to the WLAN/Bluetooth radio turning on, then the secondary RF exposure control scheme may decide to directly operate the WLAN/Bluetooth radio based on the RF exposure limit as opposed to the control level. The active radios may continue operating based on the RF exposure limit until the primary RF exposure control scheme enters the active state.

In certain aspects, the secondary RF exposure control scheme (implemented via the applications processor) may wake up the primary RF exposure control scheme intermittently to allow the primary RF exposure control scheme to compute at least one of an updated control level or an updated RF exposure limit. The secondary RF exposure control scheme may wake up the primary RF exposure control scheme upon detecting one or more conditions, such as (i) the primary RF exposure control scheme transitioning from the online state to being unavailable (e.g., to the offline state), (ii) a change in a power state of one or more active radios (e.g., WLAN/Bluetooth radio toggling between ON/OFF), and (iii) a change in a transmit scenario associated with the wireless communication device (e.g., a DSI category, antenna(s), frequency band(s), channel(s), etc.), as illustrative, non-limiting examples. In one particular example, the secondary RF exposure control scheme may trigger a wakeup of the primary RF exposure control scheme upon detecting a DSI category change, such as a change from “head” to “non-head” category or a change from “open” to “closed” for foldable wireless communication devices, as illustrative, non-limiting examples.

In certain aspects, the secondary RF exposure control scheme may be configured to trigger a wakeup of the primary RF exposure control scheme periodically, e.g., upon detecting a start of a periodic time interval. In general, when the primary RF exposure control scheme is in the offline state or otherwise unavailable (e.g., in airplane mode), the secondary RF exposure control scheme (implemented via the applications processor) can wake up the primary RF exposure control scheme on a periodic basis as called for to allow the primary RF exposure control scheme to provide updated control levels and/or updated RF exposure limits based on recent exposure usage reports. In these aspects, the updated control levels and/or updated RF exposure limits may be different than the control levels and/or RF exposure limits (described above) that are provided by the primary RF exposure control scheme when the primary RF exposure control scheme is not operating under a periodic wakeup mode.

For example, the secondary RF exposure control scheme can receive RF exposure information (e.g., RF exposure usage reports) from the WLAN/Bluetooth radios, wake up the primary RF exposure control scheme on a periodic basis (assuming the WLAN/Bluetooth radios are active), and send the RF exposure information to the primary RF exposure control scheme. The secondary RF exposure control scheme may receive updated control levels and/or updated RF exposure limits from the primary RF exposure control scheme that are determined based on the RF exposure information. The secondary RF exposure control scheme may then send the updated control levels and/or updated RF exposure limits to the WLAN/Bluetooth radios whenever the WLAN/Bluetooth radios are active and the primary RF exposure control scheme is unavailable (e.g., in the offline state). The updated control levels and/or updated RF exposure limits may be applicable for a duration of the time interval. For example, if the secondary RF exposure control scheme is periodically waking up the primary RF exposure control scheme every 5 seconds, then the updated control levels and/or the updated RF exposure limits may be applicable for 5 seconds. Note that, when the primary RF exposure control scheme is in the online state, the primary RF exposure control scheme may reassume its role of sending control levels and/or RF exposure limits to all (or some) of the active radios as well as receiving RF exposure information from all (or some) of the active radios.

In certain aspects, the primary RF exposure control scheme may operate at a different rate when the primary RF exposure control scheme is unavailable (e.g., in the offline state) compared to when the primary RF exposure control scheme is in the online state. For example, the primary RF exposure control scheme may operate at a faster rate (e.g., every 0.5 seconds) when the WWAN modem is active. When the WWAN modem is not active (e.g., in airplane mode), the secondary RF exposure control scheme (implemented via the applications processor) can wake up the primary RF exposure control scheme at a slower (or lower) periodicity (e.g., every 5 seconds) in order to allow the primary RF exposure control scheme to compute updated control levels and/or updated RF exposure limits, thereby optimizing (or at least reducing) battery consumption. In some cases, when the WWAN modem is not active, the secondary RF exposure control scheme (implemented via the applications processor) can wake up the primary RF exposure control scheme at a faster (or higher) periodicity in order to allow the primary RF exposure control scheme to compute updated control levels and/or updated RF exposure limits. For example, while waking up the primary RF exposure control scheme at a lower periodicity may help with lower battery consumption, such a lower periodicity may come at the cost of not reacting quick enough (e.g., the wireless device may lose some performance in bursty traffic scenarios or rapidly changing radio conditions, as illustrative examples).

By waking up the primary RF exposure control scheme periodically, aspects may enable the primary RF exposure control scheme to still control operation of all (or some) of the active radios even when transitioning between RF exposure control schemes, thereby allowing the wireless communication device to ensure compliance with an RF exposure limit among the radios.

Note that when the applications processor is active, the battery power consumption that is added due to waking up the primary RF exposure control scheme may be negligible, since the applications processor may consume a significant amount of battery power consumption compared to certain radios (e.g., WWAN radio) of the wireless communication device. For example, each wakeup of the applications processors may last for hundreds of milliseconds, and each wakeup of the primary RF exposure control scheme (e.g., WWAN radio) by the applications processor may add a few tens of milliseconds. As such, waking up the primary RF exposure control scheme periodically may allow the wireless communication device to run time averaging during a substantial portion of the device's operation at a negligible cost of battery power consumption.

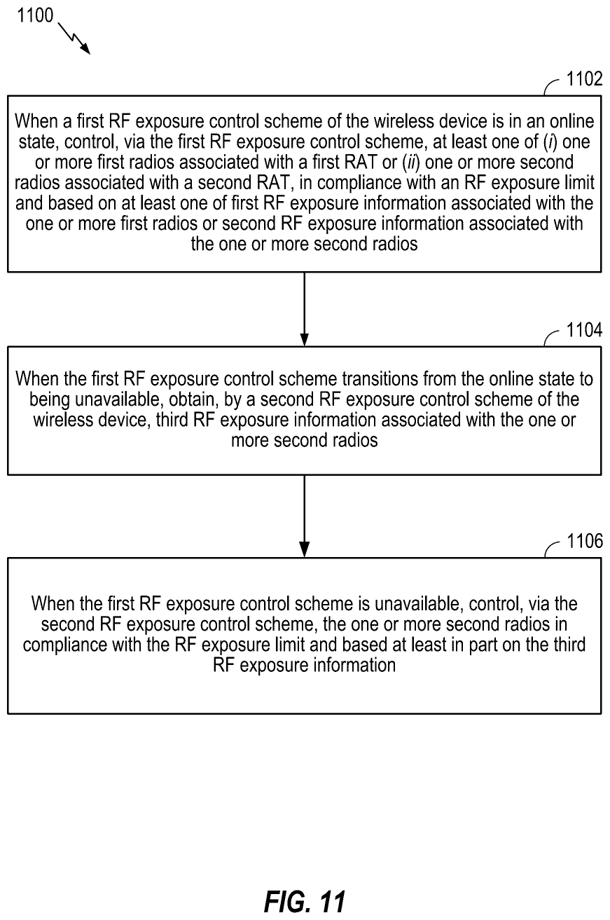

FIG. 11 is a flow diagram illustrating example operations 1100 for wireless communication, in accordance with certain aspects of the present disclosure. The operations 1100 may be performed, for example, by a wireless device (e.g., the UE 120a in the wireless communication network 100). The operations 1100 may be implemented as software components that are executed and run on one or more processors (e.g., controller/processor 280 of FIG. 2). Further, the transmission and/or reception of signals by the wireless device in the operations 1100 may be enabled, for example, by one or more antennas (e.g., antennas 252 of FIG. 2). In certain aspects, the transmission and/or reception of signals by the wireless device may be implemented via a bus interface of one or more processors (e.g., controller/processor 280) obtaining and/or outputting signals for reception or transmission.

The operations 1100 may optionally begin, at block 1102, where, when a first RF exposure control scheme of the wireless device is in an online state, the wireless device controls, via the first RF exposure control scheme, at least one of (i) one or more first radios associated with a first RAT or (ii) one or more second radios associated with a second RAT, in compliance with an RF exposure limit and based on at least one of first RF exposure information associated with the one or more first radios or second RF exposure information associated with the one or more second radios.

At block 1104, when the first RF exposure control scheme transitions from the online state to being unavailable (e.g., to an offline state), the wireless device obtains, by a second RF exposure control scheme of the wireless device, third RF exposure information associated with the one or more second radios. The third RF exposure information may be obtained from at least one storage location associated with the first RF exposure control scheme, and may correspond to a time interval (e.g., in which the first RF exposure control scheme was in the online state (e.g., t₁ to t₂ illustrated in FIG. 8).

At block 1106, when the first RF exposure control scheme is unavailable (e.g., in the offline state), the wireless device controls, via the second RF exposure control scheme, the one or more second radios in compliance with the RF exposure limit and based at least in part on the third RF exposure information.

In certain aspects, the third RF exposure information may include at least one of: (i) a first control level for the one or more second radios that applies during a first time window (e.g., t₂ to t₃ illustrated in FIG. 8) or (ii) a first RF exposure limit for the one or more second radios that applies during a second time window (e.g., t₃ to t₄ illustrated in FIG. 8) subsequent to the first time window. The first and second time windows may be associated with the second RF exposure control scheme.

In certain aspects, a value of the first control level may be based on an amount of RF exposure associated with the first RF exposure control scheme during a time interval in which the first RF exposure control scheme was in the online state (e.g., t₁ to t₂ illustrated in FIG. 8). Additionally or alternatively, in certain aspects, the operations 1100 may include the wireless device obtaining, by the second RF exposure control scheme, an indication of a power state of the one or more second radios. In such aspects, at least one of (i) a value of the first control level or (ii) a value of the first RF exposure limit may be based on the power state of the one or more second radios.

In certain aspects, controlling, via the second RF exposure control scheme, the one or more second radios (in block 1106) may include: determining a first transmission power level for the one or more second radios that applies during the first time window, based on the first control level; determining a second transmission power level for the one or more second radios that applies during the second time window, based on the first RF exposure limit; or a combination thereof.

In certain aspects, the operations 1100 may further include the wireless device determining, by the second RF control scheme, a point in time at which the first RF exposure control scheme became unavailable (e.g., entered the offline state). In such aspects, controlling, via the second RF exposure control scheme, the one or more second radios (in block 1106) may include, when the point in time is within the first time window: determining a first transmission power level for the one or more second radios that applies for at least a portion of the first time window, based on the first control level; and determining a second transmission power level for the one or more second radios that applies during the second time window, based on the first RF exposure limit.

In certain aspects, the operations 1100 may further include the wireless device determining, by the second RF control scheme, a point in time at which the first RF exposure control scheme became unavailable (e.g., entered the offline state). In such aspects, controlling, via the second RF exposure control scheme, the one or more second radios (in block 1106) may include, when the point in time is within the second time window, determining a transmission power level for the one or more second radios that applies during the second time window, based on the first RF exposure limit.

In certain aspects, the operations 1100 may further include the wireless device, upon detecting, by the second RF exposure control scheme, one or more conditions: triggering, via the second RF exposure control scheme, the first RF exposure control scheme to transition from being unavailable (e.g., from the offline state) to the online state; and when the first RF exposure control is in the online state, obtaining, by the second RF exposure control scheme, fourth RF exposure information associated with the one or more second radios from at least one storage location associated with the first RF exposure control scheme. The fourth RF exposure information may include at least one of: (i) a first control level for the one or more second radios that applies during a first time window or (ii) a first RF exposure limit for the one or more second radios that applies during a second time window subsequent to the first time window. The first and second time windows may be associated with the second RF exposure control scheme.

In some cases, the one or more conditions may include at least one of: (i) the first RF exposure control scheme transitioning from the online state to being unavailable (e.g., to the offline state); (ii) a change in a power state of the one or more second radios; or (iii) a change in a transmit scenario associated with the wireless device.

Additionally or alternatively, in some cases, the one or more conditions comprise an occurrence of a start of a first periodic time interval. In these cases, controlling, via the first RF exposure control scheme, the at least one of the one or more first radios or the one or more second radios (in block 1102) may include, upon each occurrence of a start of a second periodic time interval, determining a first transmission power level for the one or more first radios or determining a second transmission power level for the one or more second radios. The second periodic time interval may have a different periodicity (e.g., lower or higher periodicity) than the first periodic time interval.

### Example Communications Device

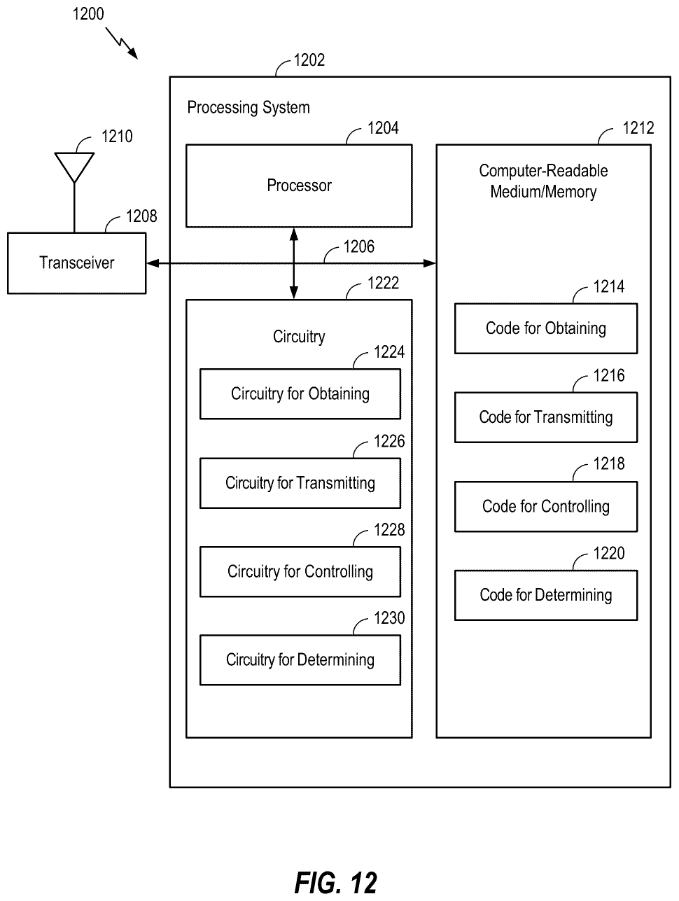

FIG. 12 illustrates a communications device 1200 (e.g., the UE 120) that may include various components (e.g., corresponding to means-plus-function components) configured to perform operations for the techniques disclosed herein, such as the operations illustrated in FIG. 9, the operations illustrated in FIG. 10, and the operations illustrated in FIG. 11. The communications device 1200 includes a processing system 1202, which may be coupled to a transceiver 1208 (e.g., a transmitter and/or a receiver). The transceiver 1208 is configured to transmit and receive signals for the communications device 1200 via an antenna 1210, such as the various signals as described herein. The processing system 1202 may be configured to perform processing functions for the communications device 1200, including processing signals received and/or to be transmitted by the communications device 1200.

The processing system 1202 includes a processor 1204 coupled to a computer-readable medium/memory 1212 via a bus 1206. In certain aspects, the computer-readable medium/memory 1212 is configured to store instructions (e.g., computer-executable code) that when executed by the processor 1204, cause the processor 1204 to perform the operations illustrated in FIG. 9, the operations illustrated in FIG. 10, the operations illustrated in FIG. 11, or other operations for performing the various techniques discussed herein for providing RF exposure compliance. In certain aspects, computer-readable medium/memory 1212 stores code for obtaining 1214, code for transmitting (or outputting for transmission or providing) 1216, code for controlling 1218, and/or code for determining 1220. In certain aspects, the processing system 1202 has circuitry 1222 configured to implement the code stored in the computer-readable medium/memory 1212. In certain aspects, the circuitry 1222 is coupled to the processor 1204 and/or the computer-readable medium/memory 1212 via the bus 1206. For example, the circuitry 1222 includes circuitry for obtaining 1224, circuitry for transmitting (or outputting for transmission or providing) 1226, circuitry for controlling 1228, and/or circuitry for determining 1230.

Means for transmitting (or means for outputting for transmission) may include a transmitter and one or more antennas, such as the transceiver 254 and/or antenna(s) 252 of the UE 120a illustrated in FIG. 2 and/or circuitry for transmitting 1226 of the communications device 1200 in FIG. 12. Means for obtaining, means for assuming, and/or means for determining may include a processing system, which may include one or more processors, such as the receive processor 258, the transmit processor 264, the TX MIMO processor 266, and/or the controller/processor 280 of the UE 120a illustrated in FIG. 2, the processing system 1202 of the communications device 1200 in FIG. 12, and/or the circuitry for obtaining 1224, circuitry for controlling 1228, and/or circuitry for determining 1230.

### Example Aspects

Implementation examples are described in the following numbered clauses:

Clause 1: A method for wireless communication performed by a wireless device, comprising: when a first radio frequency (RF) exposure control scheme of the wireless device is in an online state, controlling, via the first RF exposure control scheme, at least one of (i) one or more first radios associated with a first radio access technology (RAT) or (ii) one or more second radios associated with a second RAT, in compliance with an RF exposure limit and based on at least one of first RF exposure information associated with the one or more first radios or second RF exposure information associated with the one or more second radios; when the first RF exposure control scheme transitions from the online state to being unavailable, obtaining, by a second RF exposure control scheme of the wireless device, configuration information associated with the first RF exposure control scheme from at least one storage location associated with the first RF exposure control scheme; and when the first RF exposure control scheme is unavailable, controlling, via the second RF exposure control scheme, the at least one of (i) the one or more first radios or (ii) the one or more second radios, in compliance with the RF exposure limit and based on the configuration information and at least one of the first RF exposure information or the second RF exposure information.

Clause 2: The method of Clause 1, wherein the configuration information comprises at least one of: (i) on-off information associated with the one or more first radios and the one or more second radios, (ii) one or more transmission power control algorithms for the one or more first radios and the one or more second radios, (iii) one or more parameters associated with the RF exposure limit, (iv) one or more electronic file system (EFS) parameters, or (v) past exposure history for one or more antenna groups of the wireless communication device.

Clause 3: The method according to any of Clauses 1-2, wherein: the first RF exposure information is obtained from the one or more first radios; and the second RF exposure information is obtained from the one or more second radios.

Clause 4: The method according to any of Clauses 1-3, wherein controlling, via the first RF exposure control scheme, the at least one of the one or more first radios or the one or more second radios comprises: determining a first transmission power level for the one or more first radios that applies during a first time interval, based on at least one of a first control level or a first RF exposure limit for the one or more first radios; determining a second transmission power level for the one or more second radios that applies during a second time interval, based on at least one of a second control level or a second RF exposure limit for the one or more second radios; or a combination thereof.

Clause 5: The method according to any of Clauses 1-4, wherein controlling, via the second RF exposure control scheme, the at least one of the one or more first radios or the one or more second radios comprises: determining a first transmission power level for the one or more first radios that applies during a first time interval, based on at least one of a first control level or a first RF exposure limit for the one or more first radios; determining a second transmission power level for the one or more second radios that applies during a second time interval, based on at least one of a second control level or a second RF exposure limit for the one or more second radios; or a combination thereof.

Clause 6: A method for wireless communication performed by a wireless device, comprising: when a first radio frequency (RF) exposure control scheme of the wireless device is in an online state, controlling, via the first RF exposure control scheme, at least one of (i) one or more first radios associated with a first radio access technology (RAT) or (ii) one or more second radios associated with a second RAT, in compliance with an RF exposure limit and based on at least one of first RF exposure information associated with the one or more first radios or second RF exposure information associated with the one or more second radios; when the first RF exposure control scheme transitions from the online state to being unavailable, obtaining, by a second RF exposure control scheme of the wireless device, third RF exposure information associated with the one or more second radios; and when the first RF exposure control scheme is unavailable, controlling, via the second RF exposure control scheme, the one or more second radios in compliance with the RF exposure limit and based at least in part on the third RF exposure information.

Clause 7: The method of Clause 6, wherein the third RF exposure information is obtained from at least one storage location associated with the first RF exposure control scheme.

Clause 8: The method according to any of Clauses 6-7, wherein the third RF exposure information corresponds to a time interval in which the first RF exposure control scheme was in the online state.

Clause 9: The method according to any of Clauses 6-8, wherein the third RF exposure information comprises at least one of: (i) a first control level for the one or more second radios that applies during a first time window or (ii) a first RF exposure limit for the one or more second radios that applies during a second time window subsequent to the first time window, the first and second time windows being associated with the second RF exposure control scheme.

Clause 10: The method of Clause 9, wherein the first RF exposure limit for the one or more second radios applies until the first RF exposure control scheme enters the online state.

Clause 11: The method according to any of Clauses 9-10, wherein a value of the first control level is based on an amount of RF exposure associated with the first RF exposure control scheme during a time interval in which the first RF exposure control scheme was in the online state.

Clause 12: The method according to any of Clauses 9-10, further comprising obtaining, by the second RF exposure control scheme, an indication of a power state of the one or more second radios, wherein at least one of (i) a value of the first control level or (ii) a value of the first RF exposure limit is based on the power state of the one or more second radios.

Clause 13: The method according to any of Clauses 9-12, wherein controlling, via the second RF exposure control scheme, the one or more second radios comprises: determining a first transmission power level for the one or more second radios that applies during the first time window, based on the first control level; determining a second transmission power level for the one or more second radios that applies during the second time window, based on the first RF exposure limit; or a combination thereof.

Clause 14: The method according to any of Clauses 9-12, further comprising determining, by the second RF control scheme, a point in time at which the first RF exposure control scheme became unavailable.

Clause 15: The method of Clause 14, wherein controlling, via the second RF exposure control scheme, the one or more second radios comprises, when the point in time is within the first time window: determining a first transmission power level for the one or more second radios that applies for at least a portion of the first time window, based on the first control level; and determining a second transmission power level for the one or more second radios that applies during the second time window, based on the first RF exposure limit.

Clause 16: The method of Clause 14, wherein controlling, via the second RF exposure control scheme, the one or more second radios comprises, when the point in time is within the second time window, determining a transmission power level for the one or more second radios that applies during the second time window, based on the first RF exposure limit.

Clause 17: The method according to any of Clauses 6-16, further comprising upon detecting, by the second RF exposure control scheme, one or more conditions: triggering, via the second RF exposure control scheme, the first RF exposure control scheme to transition from being unavailable to the online state; and when the first RF exposure control is in the online state, obtaining, by the second RF exposure control scheme, fourth RF exposure information associated with the one or more second radios from at least one storage location associated with the first RF exposure control scheme.

Clause 18: The method of Clause 17, wherein the one or more conditions comprise at least one of: (i) the first RF exposure control scheme transitioning from the online state to being unavailable; (ii) a change in a power state of the one or more second radios; or (iii) a change in a transmit scenario associated with the wireless device.

Clause 19: The method according to any of Clauses 17-18, wherein the one or more conditions comprise an occurrence of a start of a first periodic time interval.

Clause 20: The method of Clause 19, wherein: controlling, via the first RF exposure control scheme, the at least one of the one or more first radios or the one or more second radios comprises, upon each occurrence of a start of a second periodic time interval, determining a first transmission power level for the one or more first radios or determining a second transmission power level for the one or more second radios; and the second periodic time interval has a lower periodicity than the first periodic time interval.

Clause 21: The method of Clause 19, wherein the fourth RF exposure information comprises at least one of: (i) a first control level for the one or more second radios that applies during the first periodic time interval or (ii) a first RF exposure limit for the one or more second radios that applies during the first periodic time interval.

Clause 22: An apparatus comprising: one or more memories collectively storing computer-executable instructions, and one or more processors coupled to the one or more memories, the one or more processors being collectively configured to execute the computer-executable instructions to cause the apparatus to perform a method in accordance with any of Clauses 1-21.

Clause 23: An apparatus for wireless communication, comprising means for performing a method in accordance with any of Clauses 1-21.

Clause 24: A non-transitory computer-readable medium comprising computer-executable instructions that, when collectively executed by one or more processors of a processing system, cause the processing system to perform a method in accordance with any of Clauses 1-21.

Clause 25: A computer program product embodied on a computer-readable storage medium comprising code for performing a method in accordance with any of Clauses 1-21.

### Additional Considerations

The techniques described herein may be used for various wireless communication technologies, such as NR (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95, and IS-856 standards. A TDMA network may implement a radio technology such as Global System for Mobile Communications (GSM). An OFDMA network may implement a radio technology such as NR (e.g., 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

In 3GPP, the term “cell” can refer to a coverage area of a Node B (NB) and/or a NB subsystem serving this coverage area, depending on the context in which the term is used. In NR systems, the term “cell” and BS, next generation NodeB (gNB or gNodeB), access point (AP), distributed unit (DU), carrier, or transmission reception point (TRP) may be used interchangeably. A BS may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a closed subscriber group (CSG), UEs for users in the home, etc.). A BS for a macro cell may be referred to as a macro BS. A BS for a pico cell may be referred to as a pico BS. A BS for a femto cell may be referred to as a femto BS or a home BS.

A UE may also be referred to as a mobile station, a terminal, an access terminal, a subscriber unit, a station, a customer premises equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, which may be narrowband IoT (NB-IoT) devices.

In some examples, access to the air interface may be scheduled. A scheduling entity (e.g., a BS) allocates resources for communication among some or all devices and equipment within the entity's service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, generating, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112 (f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the physical (PHY) layer. In the case of a UE (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer-readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read-Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein, for example, instructions for performing the operations described herein and illustrated in FIGS. 9 and 10-11.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, or a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

1. A method for wireless communication performed by a wireless device, comprising:
when a first radio frequency (RF) exposure control scheme of the wireless device is in an online state, controlling, via the first RF exposure control scheme, at least one of (i) one or more first radios associated with a first radio access technology (RAT) or (ii) one or more second radios associated with a second RAT, in compliance with an RF exposure limit and based on at least one of first RF exposure information associated with the one or more first radios or second RF exposure information associated with the one or more second radios;
when the first RF exposure control scheme transitions from the online state to being unavailable, obtaining, by a second RF exposure control scheme of the wireless device, configuration information associated with the first RF exposure control scheme from at least one storage location associated with the first RF exposure control scheme; and
when the first RF exposure control scheme is unavailable, controlling, via the second RF exposure control scheme, the at least one of (i) the one or more first radios or (ii) the one or more second radios, in compliance with the RF exposure limit and based on the configuration information and at least one of the first RF exposure information or the second RF exposure information.

2. The method of claim 1, wherein the configuration information comprises at least one of: (i) on-off information associated with the one or more first radios and the one or more second radios, (ii) one or more transmission power control algorithms for the one or more first radios and the one or more second radios, (iii) one or more parameters associated with the RF exposure limit, (iv) one or more electronic file system (EFS) parameters, or (v) past exposure history for one or more antenna groups of the wireless device.

3. The method of claim 1, wherein controlling, via the first RF exposure control scheme, the at least one of the one or more first radios or the one or more second radios comprises:
determining a first transmission power level for the one or more first radios that applies during a first time interval, based on at least one of a first control level or a first RF exposure limit for the one or more first radios;
determining a second transmission power level for the one or more second radios that applies during a second time interval, based on at least one of a second control level or a second RF exposure limit for the one or more second radios; or
a combination thereof.

4. The method of claim 1, wherein controlling, via the second RF exposure control scheme, the at least one of the one or more first radios or the one or more second radios comprises:
determining a first transmission power level for the one or more first radios that applies during a first time interval, based on at least one of a first control level or a first RF exposure limit for the one or more first radios;
determining a second transmission power level for the one or more second radios that applies during a second time interval, based on at least one of a second control level or a second RF exposure limit for the one or more second radios; or
a combination thereof.

5. A method for wireless communication performed by a wireless device, comprising:
when a first radio frequency (RF) exposure control scheme of the wireless device is in an online state, controlling, via the first RF exposure control scheme, at least one of (i) one or more first radios associated with a first radio access technology (RAT) or (ii) one or more second radios associated with a second RAT, in compliance with an RF exposure limit and based on at least one of first RF exposure information associated with the one or more first radios or second RF exposure information associated with the one or more second radios;
when the first RF exposure control scheme transitions from the online state to being unavailable, obtaining, by a second RF exposure control scheme of the wireless device, third RF exposure information associated with the one or more second radios; and
when the first RF exposure control scheme is unavailable, controlling, via the second RF exposure control scheme, the one or more second radios in compliance with the RF exposure limit and based at least in part on the third RF exposure information.

6. The method of claim 5, wherein the third RF exposure information is obtained from at least one storage location associated with the first RF exposure control scheme.

7. The method of claim 5, wherein the third RF exposure information corresponds to a time interval in which the first RF exposure control scheme was in the online state.

8. The method of claim 5, wherein the third RF exposure information comprises at least one of: (i) a first control level for the one or more second radios that applies during a first time window or (ii) a first RF exposure limit for the one or more second radios that applies during a second time window subsequent to the first time window, the first and second time windows being associated with the second RF exposure control scheme.

9. The method of claim 8, wherein the first RF exposure limit for the one or more second radios applies until the first RF exposure control scheme enters the online state.

10. The method of claim 8, wherein a value of the first control level is based on an amount of RF exposure associated with the first RF exposure control scheme during a time interval in which the first RF exposure control scheme was in the online state.

11. The method of claim 8, further comprising obtaining, by the second RF exposure control scheme, an indication of a power state of the one or more second radios, wherein at least one of (i) a value of the first control level or (ii) a value of the first RF exposure limit is based on the power state of the one or more second radios.

12. The method of claim 8, wherein controlling, via the second RF exposure control scheme, the one or more second radios comprises:
determining a first transmission power level for the one or more second radios that applies during the first time window, based on the first control level;
determining a second transmission power level for the one or more second radios that applies during the second time window, based on the first RF exposure limit; or
a combination thereof.

13. The method of claim 8, further comprising determining, by the second RF control scheme, a point in time at which the first RF exposure control scheme became unavailable.

14. The method of claim 13, wherein controlling, via the second RF exposure control scheme, the one or more second radios comprises, when the point in time is within the first time window:
determining a first transmission power level for the one or more second radios that applies for at least a portion of the first time window, based on the first control level; and
determining a second transmission power level for the one or more second radios that applies during the second time window, based on the first RF exposure limit.

15. The method of claim 13, wherein controlling, via the second RF exposure control scheme, the one or more second radios comprises, when the point in time is within the second time window, determining a transmission power level for the one or more second radios that applies during the second time window, based on the first RF exposure limit.

16. The method of claim 5, further comprising upon detecting, by the second RF exposure control scheme, one or more conditions:
triggering, via the second RF exposure control scheme, the first RF exposure control scheme to transition from being unavailable to the online state; and
when the first RF exposure control is in the online state, obtaining, by the second RF exposure control scheme, fourth RF exposure information associated with the one or more second radios from at least one storage location associated with the first RF exposure control scheme.

17. The method of claim 16, wherein the one or more conditions comprise at least one of: (i) the first RF exposure control scheme transitioning from the online state to being unavailable; (ii) a change in a power state of the one or more second radios; or (iii) a change in a transmit scenario associated with the wireless device.

18. The method of claim 16, wherein:
the one or more conditions comprise an occurrence of a start of a first periodic time interval;
controlling, via the first RF exposure control scheme, the at least one of the one or more first radios or the one or more second radios comprises, upon each occurrence of a start of a second periodic time interval, determining a first transmission power level for the one or more first radios or determining a second transmission power level for the one or more second radios; and
the second periodic time interval has a lower periodicity than the first periodic time interval.

19. The method of claim 18, wherein the fourth RF exposure information comprises at least one of: (i) a first control level for the one or more second radios that applies during the first periodic time interval or (ii) a first RF exposure limit for the one or more second radios that applies during the first periodic time interval.

20. An apparatus for wireless communication, comprising:
one or more memories collectively storing executable instructions; and
one or more processors coupled to the one or more memories, the one or more processors being collectively configured to execute the executable instructions to cause the apparatus to:
when a first radio frequency (RF) exposure control scheme of the apparatus is in an online state, control, via the first RF exposure control scheme, at least one of (i) one or more first radios associated with a first radio access technology (RAT) or (ii) one or more second radios associated with a second RAT, in compliance with an RF exposure limit and based on at least one of first RF exposure information associated with the one or more first radios or second RF exposure information associated with the one or more second radios;
when the first RF exposure control scheme transitions from the online state to being unavailable, obtain, by a second RF exposure control scheme of the apparatus, third RF exposure information associated with the one or more second radios; and
when the first RF exposure control scheme is unavailable, control, via the second RF exposure control scheme, the one or more second radios in compliance with the RF exposure limit and based at least in part on the third RF exposure information.
